(19) United States
(12) Patent Application Publication
(10) Pub. No.: US 2023/0186437 A1
(43) Pub. Date: Jun. 15, 2023

(54) DENOISING POINT CLOUDS

(71) Applicant: FARO Technologies, Inc., Lake Mary, FL (US)

(72) Inventors: Georgios BALATZIS, Fellbach (DE); Michael MÜLLER, Stuttgart (DE)

(21) Appl. No.: 18/078,193

(22) Filed: Dec. 9, 2022

Related U.S. Application Data
(60) Provisional application No. 63/289,216, filed on Dec. 14, 2021.

(51) Int. Cl. G06T 5/00; G06T 5/50; G06T 7/593

(52) U.S. Cl. CPC G06T 5/002; G06T 5/50; G06T 7/593; G06T 2207/10028; G06T 2207/20081

(57) ABSTRACT

Examples described herein provide a method for denoising data. The method includes receiving an image pair, a disparity map associated with the image pair, and a scanned point cloud associated with the image pair. The method includes generating, using a machine learning model, a predicted point cloud based at least in part on the image pair and the disparity map. The method includes comparing the scanned point cloud to the predicted point cloud to identify noise in the scanned point cloud. The method includes generating a new point cloud without at least some of the noise based at least in part on comparing the scanned point cloud to the predicted point cloud.

### CROSS-REFERENCE TO RELATED APPLICATIONS

This application claims the benefit of U.S. Provisional Pat. Application Serial No. 63/289,216 filed Dec. 14, 2021, the disclosure of which is incorporated herein by reference in its entirety.

### BACKGROUND

Embodiments of the present disclosure generally relate to image processing and, in particular, to techniques for denoising point clouds.

The acquisition of three-dimensional coordinates of an object or an environment is known. Various techniques may be used, such as time-of-flight (TOF) or triangulation methods, for example. A TOF system such as a laser tracker, for example, directs a beam of light such as a laser beam toward a retroreflector target positioned over a spot to be measured. An absolute distance meter (ADM) is used to determine the distance from the distance meter to the retroreflector based on the length of time it takes the light to travel to the spot and return. By moving the retroreflector target over the surface of the object, the coordinates of the object surface may be ascertained. Another example of a TOF system is a laser scanner that measures a distance to a spot on a diffuse surface with an ADM that measures the time for the light to travel to the spot and return. TOF systems have advantages in being accurate, but in some cases may be slower than systems that project a pattern such as a plurality of light spots simultaneously onto the surface at each instant in time.

In contrast, a triangulation system, such as a scanner, projects either a line of light (e.g., from a laser line probe) or a pattern of light (e.g., from a structured light) onto the surface. In this system, a camera is coupled to a projector in a fixed mechanical relationship. The light/pattern emitted from the projector is reflected off of the surface and detected by the camera. Since the camera and projector are arranged in a fixed relationship, the distance to the object may be determined from captured images using trigonometric principles. Triangulation systems provide advantages in quickly acquiring coordinate data over large areas.

In some systems, during the scanning process, the scanner acquires, at different times, a series of images of the patterns of light formed on the object surface. These multiple images are then registered relative to each other so that the position and orientation of each image relative to the other images are known. Where the scanner is handheld, various techniques have been used to register the images. One common technique uses features in the images to match overlapping areas of adjacent image frames. This technique works well when the object being measured has many features relative to the field of view of the scanner. However, if the object contains a relatively large flat or curved surface, the images may not properly register relative to each other.

Accordingly, while existing 3D scanners are suitable for their intended purposes, what is needed is a 3D scanner having certain features of one or more embodiments of the present invention.

### SUMMARY

Embodiments of the present invention are directed to surface defect detection.

A non-limiting example method for denoising data is provided. The method includes receiving an image pair, a disparity map associated with the image pair, and a scanned point cloud associated with the image pair. The method includes generating, using a machine learning model, a predicted point cloud based at least in part on the image pair and the disparity map. The method includes comparing the scanned point cloud to the predicted point cloud to identify noise in the scanned point cloud. The method includes generating a new point cloud without at least some of the noise based at least in part on comparing the scanned point cloud to the predicted point cloud.

In addition to one or more of the features described above, or as an alternative, further embodiments of the method include that generating the predicted point cloud includes: generating, using the machine learning model, a predicted disparity map based at least in part on the image pair; and generating the predicted point cloud using the predicted disparity map.

In addition to one or more of the features described above, or as an alternative, further embodiments of the method include that generating the predicted point cloud using the predicted disparity map includes performing triangulation to generate the predicted point cloud.

In addition to one or more of the features described above, or as an alternative, further embodiments of the method include that the noise is identified by performing a union operation to identify points in the scanned point cloud and to identify points in the predicted point cloud.

In addition to one or more of the features described above, or as an alternative, further embodiments of the method include that the new point cloud includes at least one of the points in the scanned point cloud and at least one of the points in the predicted point cloud.

In addition to one or more of the features described above, or as an alternative, further embodiments of the method include that the machine learning model is trained using a random forest algorithm.

In addition to one or more of the features described above, or as an alternative, further embodiments of the method include that the random forest algorithm is a HyperDepth random forest algorithm.

In addition to one or more of the features described above, or as an alternative, further embodiments of the method include that the random forest algorithm includes a classification portion that runs a random forest function to predict, for each pixel of the image pair, a class by sparsely sampling a two-dimensional neighborhood.

In addition to one or more of the features described above, or as an alternative, further embodiments of the method include that the random forest algorithm includes a regression that predicts continuous class labels that maintain subpixel accuracy.

Another non-limiting example method includes receiving training data, the training data including training pairs of stereo images and a training disparity map associated with each training pair of the pairs of stereo images. The method further includes training, using a random forest approach, a machine learning model based at least in part on the training data, the machine learning model being trained to denoise a point cloud.

In addition to one or more of the features described above, or as an alternative, further embodiments of the method include that the training data are captured by a scanner.

In addition to one or more of the features described above, or as an alternative, further embodiments of the method include receiving an image pair, a disparity map associated with the image pair, and the point cloud; generating, using the machine learning model, a predicted point cloud based at least in part on the image pair and the disparity map; comparing the point cloud to the predicted point cloud to identify noise in the point cloud; and generating a new point cloud without the noise based at least in part on comparing the point cloud to the predicted point cloud.

A non-limiting example scanner includes a projector, a camera, a memory, and a processing device. The memory includes computer readable instructions and a machine learning model trained to denoise point clouds. The processing device is for executing the computer readable instructions. The computer readable instructions control the processing device to perform operations. The operations include to generate a point cloud of an object of interest. The operations further include to generate a new point cloud by denoising the point cloud of the object of interest using the machine learning model.

In addition to one or more of the features described above, or as an alternative, further embodiments of the scanner include that the machine learning model is trained using a random forest algorithm.

In addition to one or more of the features described above, or as an alternative, further embodiments of the scanner include that the camera is a first camera, the scanner further including a second camera.

In addition to one or more of the features described above, or as an alternative, further embodiments of the scanner include that capturing the point cloud of the object of interest includes acquiring a pair of images of the object of interest using the first camera and the second camera.

In addition to one or more of the features described above, or as an alternative, further embodiments of the scanner include that capturing the point cloud of the object of interest further includes calculating a disparity map for the pair of images.

In addition to one or more of the features described above, or as an alternative, further embodiments of the scanner include that capturing the point cloud of the object of interest further includes generating the point cloud of the object of interest based at least in part on the disparity map.

In addition to one or more of the features described above, or as an alternative, further embodiments of the scanner include that denoising the point cloud of the object of interest using the machine learning model includes generating, using the machine learning model, a predicted point cloud based at least in part on an image pair and a disparity map associated with the object of interest.

In addition to one or more of the features described above, or as an alternative, further embodiments of the scanner include that denoising the point cloud of the object of interest using the machine learning model further includes comparing the point cloud of the object of interest to the predicted point cloud to identify noise in the point cloud of the object of interest.

In addition to one or more of the features described above, or as an alternative, further embodiments of the scanner include that denoising the point cloud of the object of interest using the machine learning model further includes generating the new point cloud without the noise based at least in part on comparing the point cloud of the object of interest to the predicted point cloud.

### BRIEF DESCRIPTION OF THE DRAWINGS

The subject matter, which is regarded as the invention, is particularly pointed out and distinctly claimed in the claims at the conclusion of the specification. The foregoing and other features, and advantages of embodiments of the invention are apparent from the following detailed description taken in conjunction with the accompanying drawings in which:

FIG. 1 depicts a system for scanning an object according to one or more embodiments described herein;

FIG. 2 depicts a system for generating a machine learning model useful for denoising point clouds according to one or more embodiments described herein;

FIG. 3 depicts a random forest approach to training a machine learning model according to one or more embodiments described herein;

FIGS. 4A and 4B depict a system for training a machine learning model according to one or more embodiments described herein;

FIG. 5 depicts a flow diagram of a method for training a machine learning model according to one or more embodiments described herein

FIGS. 6A and 6B depict a system for performing inference using a machine learning model according to one or more embodiments described herein.

FIG. 7 depicts a flow diagram of a method for denoising data, such as a point cloud, according to one or more embodiments described herein;

FIG. 8A depicts an example scanned point cloud according to one or more embodiments described herein;

FIG. 8B depicts an example predicted point cloud according to one or more embodiments described herein;

FIG. 9 depicts an example new point cloud as a comparison between the scanned point cloud of FIG. 8A and the predicted point cloud of FIG. 8B according to one or more embodiments described herein;

FIGS. 10A and 10B depict a modular inspection system according to one or more embodiments described herein;

FIGS. 11A-11E are isometric, partial isometric, partial top, partial front, and second partial top views, respectively, of a triangulation scanner according to one or more embodiments described herein;

FIG. 12A is a schematic view of a triangulation scanner having a projector, a first camera, and a second camera according to one or more embodiments described herein;

FIG. 12B is a schematic representation of a triangulation scanner having a projector that projects and uncoded pattern of uncoded spots, received by a first camera, and a second camera according to one or more embodiments described herein;

FIG. 12C is an example of an uncoded pattern of uncoded spots according to one or more embodiments described herein;

FIG. 12D is a representation of one mathematical method that might be used to determine a nearness of intersection of three lines according to one or more embodiments described herein;

FIG. 12E is a list of elements in a method for determining 3D coordinates of an object according to one or more embodiments described herein;

FIG. 13 is an isometric view of a triangulation scanner having a projector and two cameras arranged in a triangle according to one or more embodiments described herein;

FIG. 14 is a schematic illustration of intersecting epipolar lines in epipolar planes for a combination of projectors and cameras according to one or more embodiments described herein;

FIGS. 15A, 15B, 15C, 15D, 15E are schematic diagrams illustrating different types of projectors according to one or more embodiments described herein;

FIG. 16A is an isometric view of a triangulation scanner having two projectors and one camera according to one or more embodiments described herein;

FIG. 16B is an isometric view of a triangulation scanner having three cameras and one projector according to one or more embodiments described herein;

FIG. 16C is an isometric view of a triangulation scanner having one projector and two cameras and further including a camera to assist in registration or colorization according to one or more embodiments described herein;

FIG. 17A illustrates a triangulation scanner used to measure an object moving on a conveyor belt according to one or more embodiments described herein;

FIG. 17B illustrates a triangulation scanner moved by a robot end effector, according to one or more embodiments described herein; and

FIG. 18 illustrates front and back reflections off a relatively transparent material such as glass according to one or more embodiments described herein.

### DETAILED DESCRIPTION

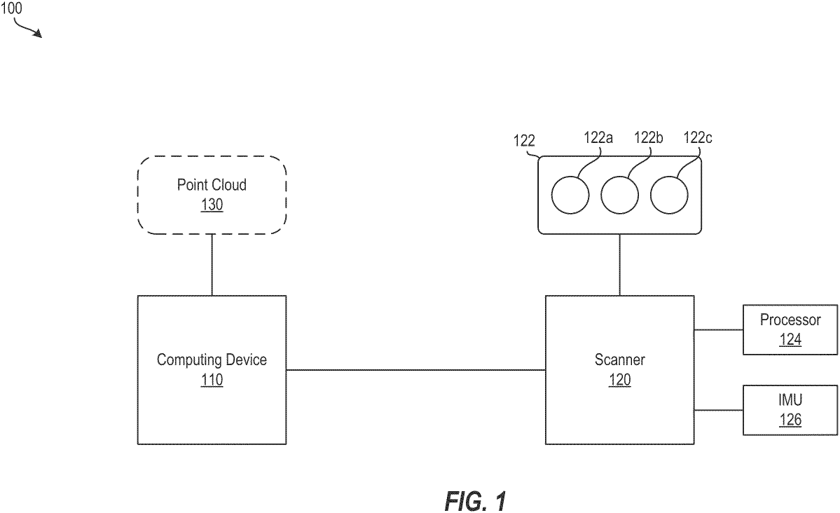

The technical solutions described herein generally relate to techniques for denoising point clouds. A three-dimensional (3D) scanning device (also referred to as a “scanner,” “imaging device,” and/or “triangulation scanner”) as depicted in FIG. 1, for example, can scan an object to perform quality control, which can include detecting surface defects on a surface of the object. A surface defect can include a scratch, a dent, or the like. Particularly, a scan is performed by capturing images of the object as described herein, such as using a triangulation scanner. As an example, triangulation scanners can include a projector and two cameras. The projector and two cameras are separated by known distances in a known geometric arrangement. The projector projects a pattern (e.g., a structured light pattern) onto an object to be scanned. Images of the object having the pattern projected thereon are captured using the two cameras, and 3D points are extracted from these images to generate a point cloud representation of the object. However, the images and/or point cloud can include noise. The noise may be a result of the object to be scanned, the scanning environment, limitations of the scanner (e.g., limitations on resolution), or the like. As an example of limitations of the scanner, some scanners have a 2-sigma (2σ) noise of about 500 micrometers (µm) at a 0.5 meter (m) measurement distance. This can cause such a scanner to be usable in certain applications because of the noise introduced.

An example of a conventional technique for denoising point clouds involves repetitive measurements of a particular object, which can be used to remove the noise. Another example of a conventional technique for denoising point clouds involves higher resolution, higher accuracy scans with very limited movement of the object/scanner. However, the conventional approaches are slow and use extensive resources. For example, performing the repetitive scans uses additional processing resources (e.g., multiple scanning cycles) and takes more time than scanning the object once. Similarly, performing higher resolution, higher accuracy scans requires higher resolution scanning hardware and additional processing resources to process the higher resolution data. These higher resolution, higher accuracy scans are slower and thus take more time.

Another example of a conventional technique for denoising point clouds uses filters in image processing, photogrammetry, etc. For example, statistical outlier removal can be used to remove noise; however, such an approach is time consuming. Further, such approach requires parameters to be tuned, and no easy and fast way to preview results during the tuning exists. Moreover, there is no filter / parameter set that provides optimal results for different kinds of noise. Depending on the time and resources available, it may not even be possible to identify an “optimal” configuration. These approaches are resource and time intensive and are therefore often not acceptable or feasible in scanning environments where time and resources are not readily available.

One or more embodiments described herein use an artificial intelligence (AI) to denoise, in real-time or near-real-time (also referred to as “on-the-fly”), point cloud data without the limitations of conventional techniques. For example, as a scanner scans an object of interest and the scanner applies a trained machine learning model to denoise the point cloud generated from the scan.

Unlike conventional approaches to denoising point clouds, the present techniques reduce the amount of time and resources needed to denoise point clouds. That is, the present techniques utilize a trained machine learning model to denoise point clouds without performing repetitive scans or performing a higher accuracy, higher resolution scan. Thus, the present techniques provide faster and more precise point cloud denoising by using the machine learning model. To achieve these and other advantages, one or more embodiments described herein trains a machine learning model (e.g., using a random forest algorithm) to denoise images.

Turning now to the figures, FIG. 1 depicts a system 100 for scanning an object according to one or more embodiments described herein. The system 100 includes a computing device 110 coupled with a scanner 120, which can be a 3D scanner or another suitable scanner. The coupling facilitates wired and/or wireless communication between the computing device 110 and the scanner 120. The scanner 120 includes a set of sensors 122. The set of sensors 122 can include different types of sensors, such as LIDAR sensor 122A (light detection and ranging), RGB-D camera 122B (red-green-blue-depth), and wide-angle/fisheye camera 122C, and other types of sensors. The scanner 120 can also include an inertial measurement unit (IMU) 126 to keep track of a 3D movement and orientation of the scanner 120. The scanner 120 can further include a processor 124 that, in turn, includes one or more processing units. The processor 124 controls the measurements performed using the set of sensors 122. In one or more examples, the measurements are performed based on one or more instructions received from the computing device 110. In an embodiment, the LIDAR sensor 122A is a two-dimensional (2D) scanner that sweeps a line of light in a plane (e.g. a plane horizontal to the floor).

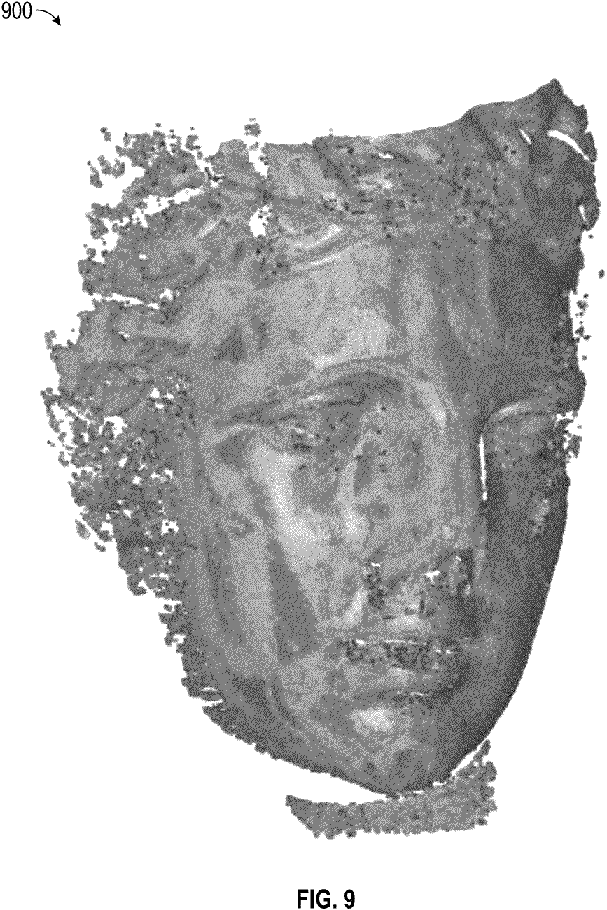

According to one or more embodiments described herein, the scanner 120 is a dynamic machine vision sensor (DMVS) scanner manufactured by FARO® Technologies, Inc. of Lake Mary, Florida, USA. DMVS scanners are discussed further with reference to FIGS. 11A-18. In an embodiment, the scanner 120 may be that described in commonly owned U.S. Pat. Publication No. 2018/0321383, the contents of which are incorporated by reference herein in their entirety. It should be appreciated that the techniques described herein are not limited to use with DMVS scanners and that other types of 3D scanners can be used.

The computing device 110 can be a desktop computer, a laptop computer, a tablet computer, a phone, or any other type of computing device that can communicate with the scanner 120.

In one or more embodiments, the computing device 110 generates a point cloud 130 (e.g., a 3D point cloud) of the environment being scanned by the scanner 120 using the set of sensors 122. The point cloud 130 is a set of data points (i.e., a collection of three-dimensional coordinates) that correspond to surfaces of objects in the environment being scanned and/or of the environment itself. According to one or more embodiments described herein, a display (not shown) displays a live view of the point cloud 130. In some cases, the point cloud 130 can include noise. One or more embodiments described herein provide for removing noise from the point cloud 130.

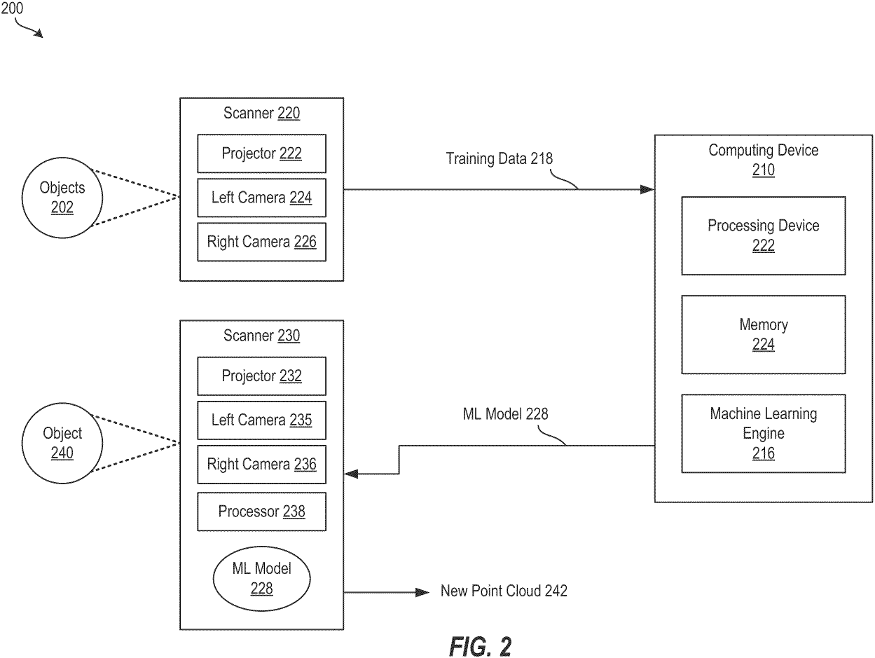

FIG. 2 depicts an example of a system 200 for generating a machine learning model useful for denoising point clouds according to one or more embodiments described herein. The system 200 includes a computing device 210 (i.e., a processing system), a scanner 220, and a scanner 230. The system 200 uses the scanner 220 to collect training data 218, uses the computing device 210 to train a machine learning model 228 from the training data 218, and uses the scanner 230 to scan an object 240 to generate a point cloud and to denoise the point cloud to generate a new point cloud 242 representative the object 240 using the machine learning model 228. The new point cloud 242 has noised removed therefrom.

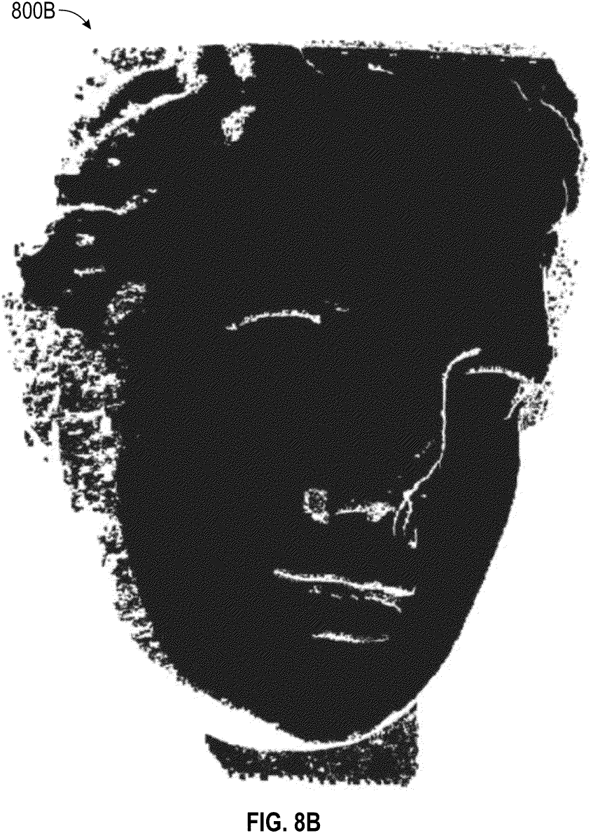

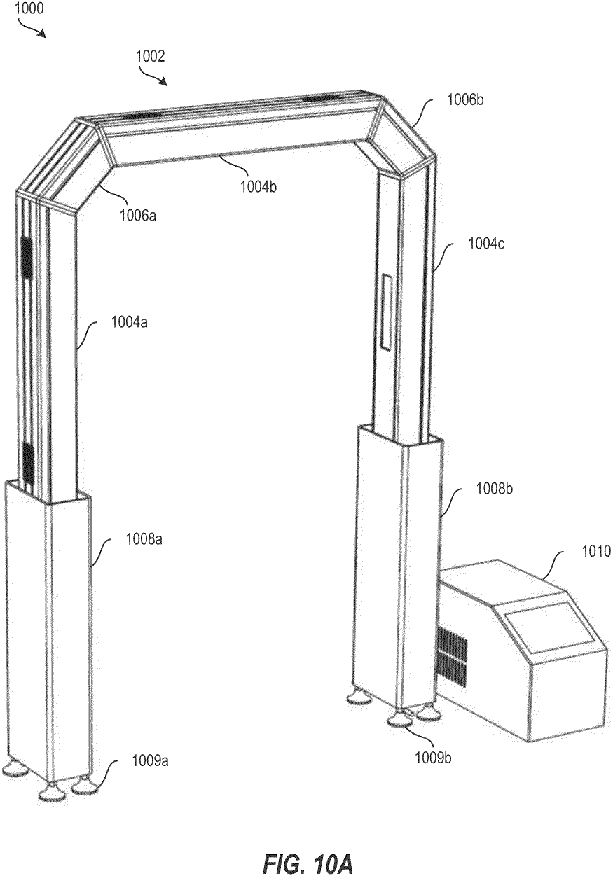

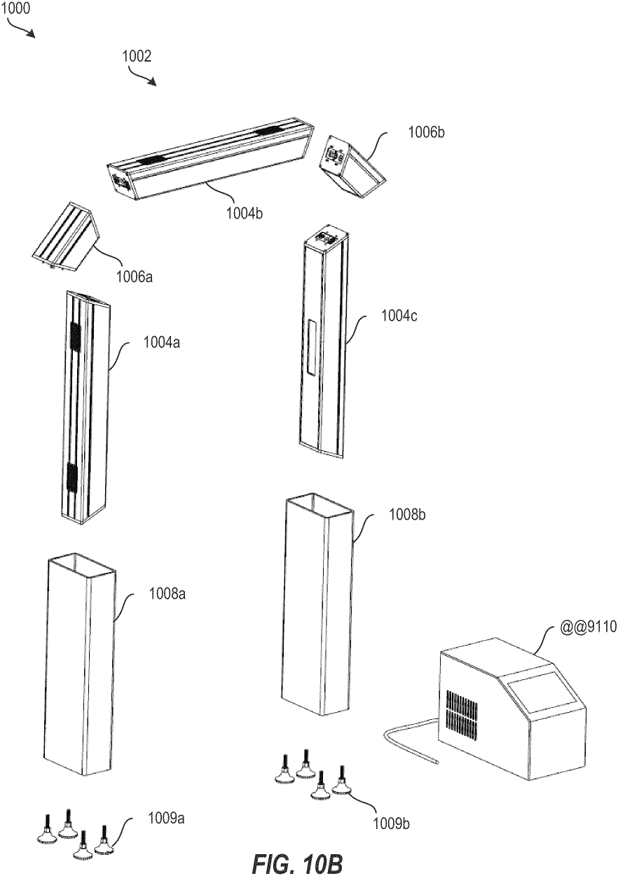

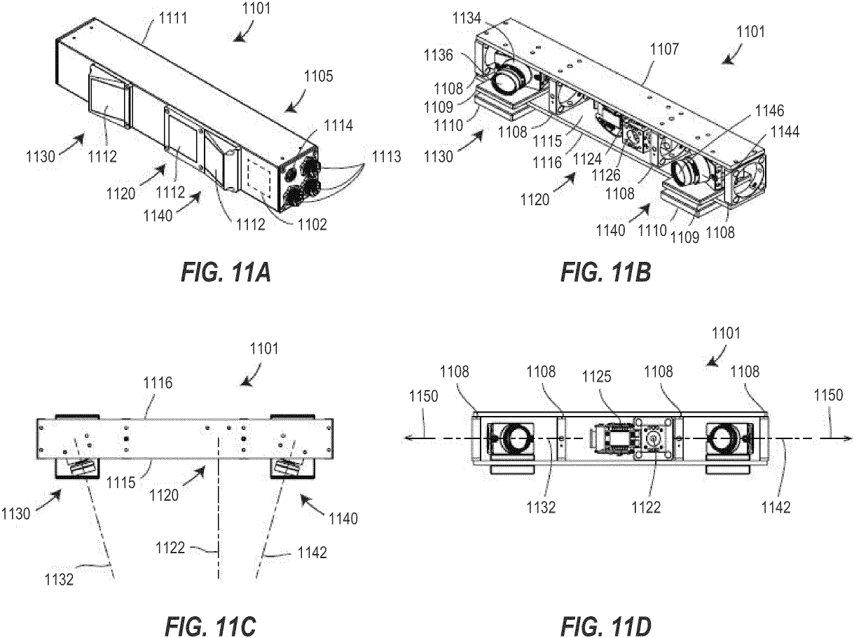

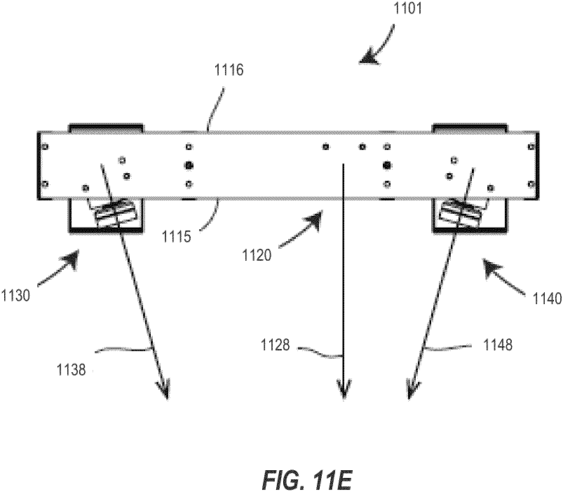

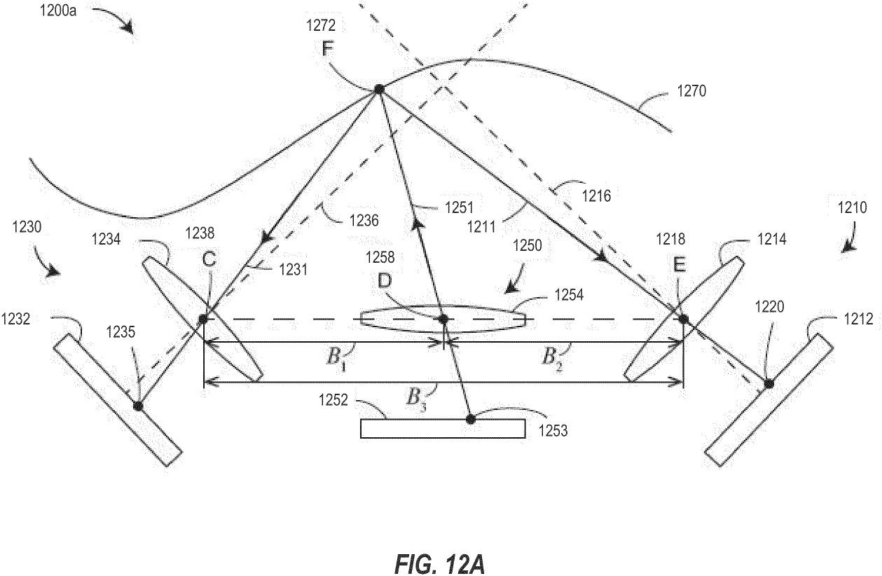

The scanner 220 (which is one example of the scanner 120 of FIG. 1) scans objects 202 to capture images of the objects 202 used for training a machine learning model 228. The scanner 220 can be any suitable scanner, such as the triangulator scanner shown in FIGS. 11A-11E, that includes a projector and cameras. For example, the scanner 220 includes a projector 222 that projects a light pattern on the objects 202. The light pattern can be any suitable pattern, such as those described herein, and can include a structured-light pattern, a pseudorandom pattern, etc. See, for example, the discussion of FIGS. 10A and 12A, which describe projecting a pattern of light over an area on a surface, such as a surface of each of the objects 202. The scanner 220 also includes a left camera 224 and a right camera 226 (collectively referred to herein as “cameras 224, 226”) to capture stereoscopic views, e.g., “left eye” and “right eye” views, of the objects 202. The cameras 224, 226 are spaced apart such that images captured by the respective cameras 224, 226 depict the objects 202 from different points-of-view. See, for example, the discussion of FIGS. 10A and 12A, which describe capturing images of the pattern of light (projected by the projector) on the surface, such as the surface of the objects 202. According to one or more embodiments described herein, the cameras 224, 226 capture images of the objects 202 having the light pattern projected thereon at substantially the same time. For example, at a particular point in time, the left camera 224 and the right camera 226 each capture images of one of the objects 202. Together, these two images (left image and right image) are referred to as an image pair or frame. The cameras 224, 226 can capture multiple image pairs of the objects 202. Once the cameras 224, 226 capture the image pairs of the objects 202, the image pairs are sent to the computing device 210 as training data 218.

The computing device 210 (which is one example of the computing device 110 of FIG. 1) receives the training data 218 (e.g., image pairs and a disparity map for each set of image pairs) from the scanner 220 via any suitable wired and/or wireless communication technique directly and/or indirectly (such as via a network). According to one or more embodiments described herein, computing device 210 receives training images from the scanner 220 and computes a disparity map for each set of the training images. The disparity map encodes the difference in pixels for each point seen by both the left camera 224 and the right camera 226 viewpoints. In other examples, the scanner 220 computes the disparity map for each set of training images and transmits the disparity map as part of the training data 218 to the computing device 210. According to one or more embodiments described herein, computing device 210 and/or the scanner 220 also computes a point cloud of the objects 202 from the set of training images.

The computing device 210 includes a processing device 212, a memory 214, and a machine learning engine 216. The various components, modules, engines, etc. described regarding the computing device 210 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the machine learning engine 216 can be a combination of hardware and programming or be a codebase on a computing node of a cloud computing environment. The programming can be processor executable instructions stored on a tangible memory, and the hardware can include the processing device 212 for executing those instructions. Thus a system memory (e.g., memory 214) can store program instructions that when executed by the processing device 212 implement the machine learning engine 216. Other engines can also be utilized to include other features and functionality described in other examples herein.

The machine learning engine 216 generates a machine learning (ML) model 228 using the training data 218. According to one or more embodiments described herein, training the machine learning model 228 is a fully automated process that uses machine learning to take as input a single image (or image pair) of an object and provide as output a predicted disparity map. The predicted disparity map can be used to generate a predicted point cloud. For example, the points of the predicted disparity map are converted into 3D coordinates to form the predicted point cloud using, for example, triangulation techniques.

As described herein, a neural network can be trained to denoise a point cloud. More specifically, the present techniques can incorporate and utilize rule-based decision making and artificial intelligence reasoning to accomplish the various operations described herein, namely denoising point clouds for triangulation scanners, for example. The phrase “machine learning” broadly describes a function of electronic systems that learn from data. A machine learning system, module, or engine (e.g., the machine learning engine 216) can include a trainable machine learning algorithm that can be trained, such as in an external cloud environment, to learn functional relationships between inputs and outputs that are currently unknown, and the resulting model can be used for generating disparity maps.

In one or more embodiments, machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANN that are particularly useful at analyzing visual imagery.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network’s designer, the activation of these input neurons are then passed to other downstream neurons, which are often referred to as “hidden” neurons. This process is repeated until an output neuron is activated. The activated output neuron determines which character was read. It should be appreciated that these same techniques can be applied in the case of generating disparity maps as described herein.

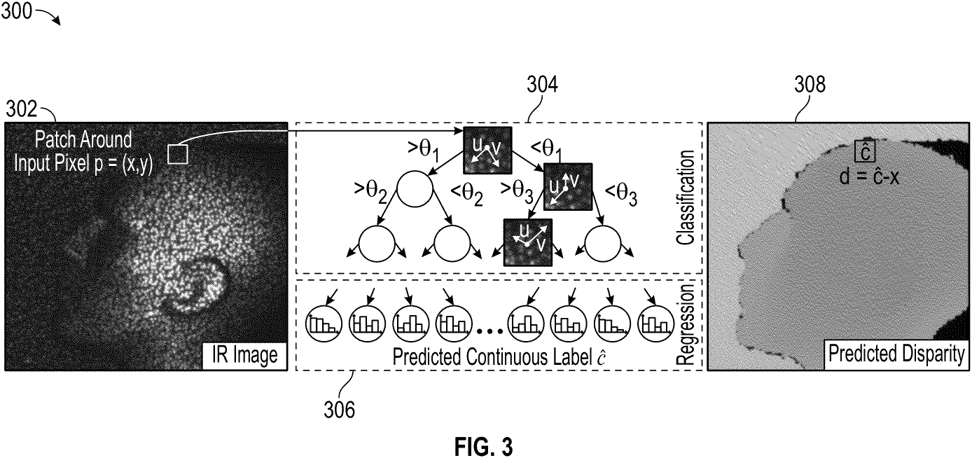

The machine learning engine 216 can generate the machine learning model 228 using one or more different techniques. As one example, the machine learning engine 216 generates the machine learning model 228 using a random forest approach as described herein with reference to FIG. 3. In particular, FIG. 3 depicts a random forest approach to training a machine learning model according to one or more embodiments described herein. For example, another possible approach to training a machine learning model is a HyperDepth random forest algorithm, which is used to predict a correct disparity in real-time (or near real-time). This is achieved by feeding the algorithm lighting images (e.g., the training data 218), avoiding triangulation to get depth map information, and getting a predicted disparity value for each pixel of the training data 218. This approach to disparity estimation uses decision trees as shown in FIG. 3. The random forest algorithm architecture 300 takes as input an infrared (IR) image 302 as training data (e.g., the training data 218), which is an example of a structured lighting image. The IR image 302 is formed from individual pixels p having coordinates (x,y). The IR image 302 is passed into a classification portion 304 of the random forest algorithm architecture 300. In the classification portion 304, for each pixel p = (x,y) in the IR image 302, a random forest function (i.e., RandomForest(middle)) is run that predicts a class c by sparsely sampling a 2D neighborhood around p. The forest starts with classification at the classification portion 304 then proceeds to performing regression at the regression portion 306 of the random forest algorithm architecture 300. During regression, continuous class labels c^ are predicted that maintain subpixel accuracy. The mapping d = c^ x gives the actual disparity d(right) for the pixel p. This algorithm is applied to each pixel p, and the actual disparity for each pixel is combined to generate the predicted disparity map 308.

With continued reference to FIG. 2, once trained, the machine learning model 228 is passed to the scanner 230, which enables the scanner 230 to use the machine learning model 228 during an inference process. The scanner 230 can be the same scanner as the scanner 220 in some examples or can be a different scanner in other examples. In the case the scanners 220, 230 are different scanners, the scanners 220, 230 can be the same type/configuration of scanner or the scanner 230 can be a different type/configurations of scanner than the scanner 220. In the example of FIG. 2, the scanner 230 includes a projector 232 to project a light pattern on the object 240. The scanner 230 also includes a left camera 235 and a right camera 236 to capture images of the object 240 having the light pattern projected thereon. The scanner 230 also includes a processor 238 that processes the images captured by the cameras 235, 236 using the machine learning model 228 to take as input an image of the object 240 and to denoise the image of the object 240 to generate a new point cloud 242 associated with the object 240. Thus, the scanner 230 acts as an edge computing device that can denoise data acquired by the scanner 230 to generate a point cloud having reduced or no noise.

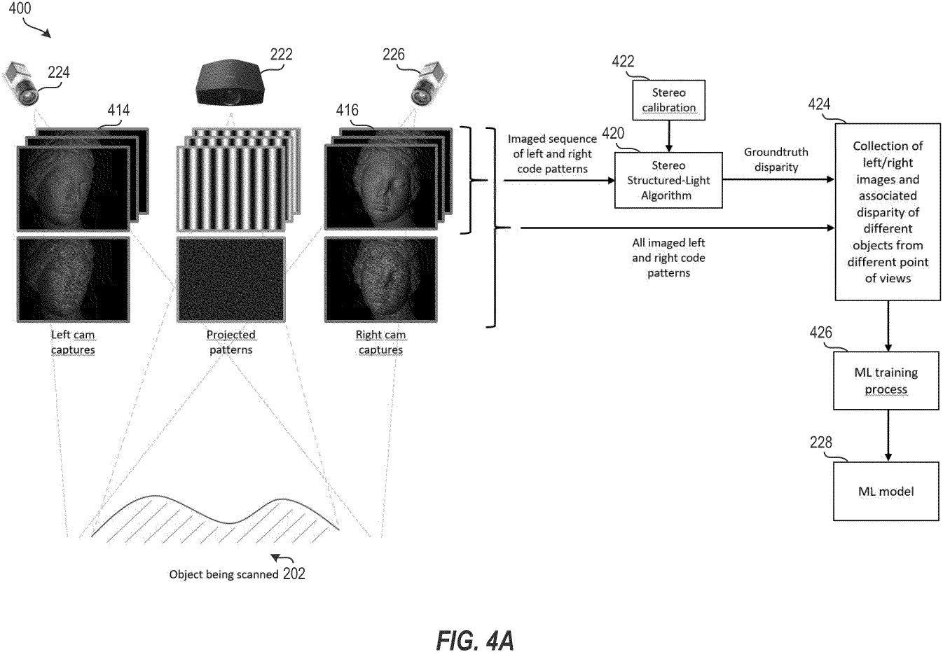

FIGS. 4A and 4B depict a system 400 for training a machine learning model (e.g., the machine learning model 228) according to one or more embodiments described herein. In this example, the system 400 includes the projector 222, the left camera 224, and the right camera 226. The cameras 224, 226 form a pair of stereo cameras. The projector 222 projects patterns of light on the object(s) 202 (as described herein), and the left camera 224 and the right camera 226 capture left images 414 and right images 416 respectively. In examples, the light patterns are structured light patterns, which are a sequence of code patterns and can be one or more of the following structured light code patterns: a gray code + phase shift, a multiple wave length phase-shift, a multiple phase-shift, etc. In examples, the light pattern is a single code pattern, which can be one or more of the following structured or unstructured light code patterns: sinusoid, pseudorandom, etc.

The projector 222 is a programmable pattern projector such as a digital light projector (DLP), a MEMS projector, a liquid crystal display (LCD) projector, liquid crystal technology on silicon (LCoS) projector, or the like. In some example, as shown in FIG. 20B, a fixed pattern projector 412 (e.g., a laser projector, a chrome on glass LCD projector, a diffractive optical element (DOE) projector, a MEMS projector, etc.) can also be used.

Once the images 414, 416 are captured, they are passed as imaged sequence of left and right code patterns to a stereo structured-light algorithm 420. The algorithm 420 calculates a ground truth disparity map. An example of the algorithm 420 is to search the image (pixel) coordinates of the same “unwrapped phase” value in the two images exploiting epipolar constraint (see, e.g., “Surface Reconstruction Based on Computer Stereo Vision Using Structured Light Projection” by Lijun Li et al. published in “2009 International Conference on Intelligent Human-Machine Systems and Cybernetics,” 26-27 Aug. 2009, which is incorporated by reference herein in its entirety). The algorithms 420 can be calibrated using a stereo calibration 422, which can consider the position of the cameras 224, 226 relative to one another. The disparity map from the algorithms 420 is passed to a collection 424 of left/right images and associated disparity map of different objects from different points of view. The imaged left and right code patterns are also passed to the collection 424 and associated with the respective ground truth disparity map.

The collection 424 represents training data (e.g., the training data 218), which is used to train a machine learning model at block 426. The training is performed, for example, using one of the training techniques described herein (see, e.g., FIG. 3). This results in the trained machine learning model 228.

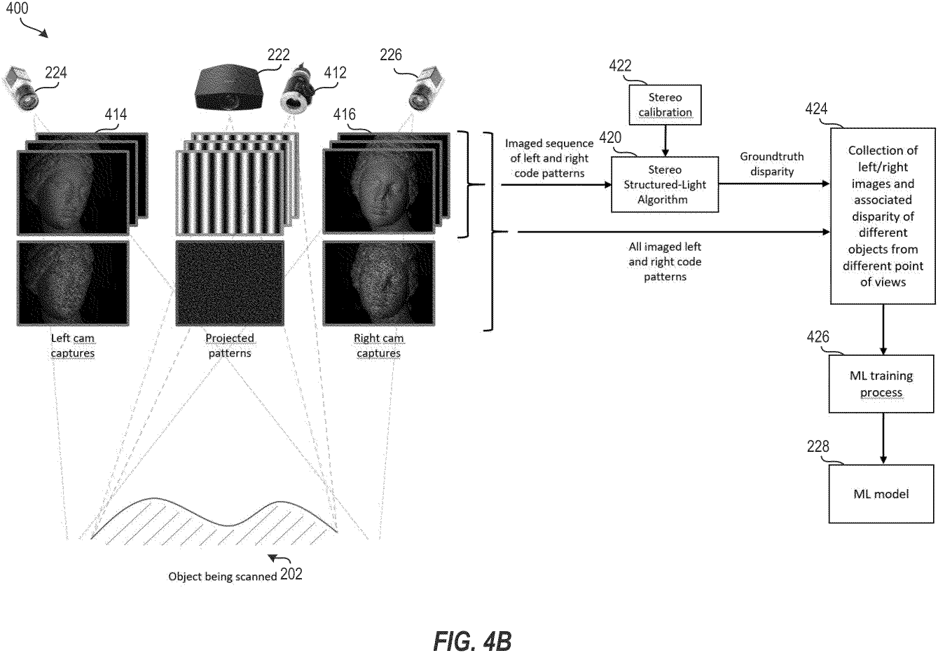

FIG. 5 depicts a flow diagram of a method 500 for training a machine learning model according to one or more embodiments described herein. The method 500 can be performed by any suitable computing device, processing system, processing device, scanner, etc. such as the computing devices, processing systems, processing devices, and scanners described herein. The aspects of the method 500 are now described in more detail with reference to FIG. 2 but are not so limited.

At block 502, a processing device (e.g., the computing device 210 of FIG. 2) receives training data (e.g., the training data 218). The training data includes pairs of stereo images and a training disparity map associated with each training pair of the pairs of stereo images. For example, the scanner 220 captures an image of the object(s) 202 with the left camera 224 and an image of the object(s) 202 with the right camera 226. Together, these images form a pair of stereo images. A disparity map can also be calculated (such as by the scanner 220 and/or by the computing device 210) for the pair of stereo images as described herein.

At block 504, the computing device 210, using the machine learning engine 216, trains a machine learning model (e.g., the machine learning model 228) based at least in part on the training data as described herein (see, e.g., FIGS. 4A, 4B). The machine learning model is trained to denoise a point cloud.

At block 506, the computing device 210 transmits the trained machine learning model (e.g., the machine learning model 228) to a scanner (e.g., the scanner 230) and/or stores the trained machine model locally. Transmitting the trained machine learning model to the scanner enables the scanner to perform inference using the machine learning model. That is, the scanner is able to act as an edge processing device that can capture scan data and use the machine learning model 228 to denoise a point cloud in real-time or near-real-time without having to waste the time or resources to transmit the data back to the computing device 210 before it can be processed. This represents an improvement to scanners, such as 3D triangulation scanners.

Additional processes also may be included, and it should be understood that the process depicted in FIG. 5 represents an illustration, and that other processes may be added or existing processes may be removed, modified, or rearranged without departing from the scope of the present disclosure.

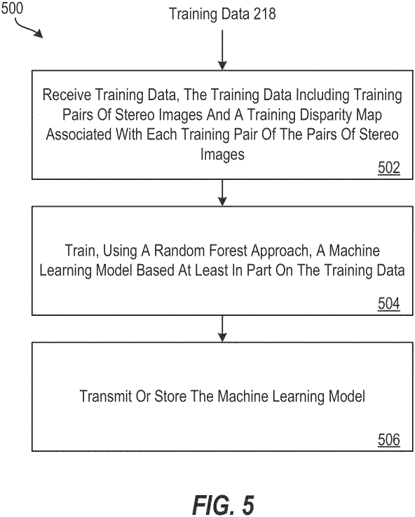

Once trained, the machine learning model is used during an inference process to generate a new point cloud without noise (or with less noise than the scanned point cloud). FIGS. 6A and 6B depict a system 600 for performing inference using a machine learning model (e.g., the machine learning model 228) according to one or more embodiments described herein. In this example, the system 600 includes the projector 232, the left camera 235, and the right camera 236. The cameras 234, 236 form a pair of stereo cameras. The projector 232 projects a pattern of light on the object 240 (as described herein), and the left camera 235 and the right camera 236 capture left image 634 and right image 636 respectively. The pattern of light is a single code pattern, which can be one or more of the following structured or unstructured light code patterns: sinusoid, pseudorandom, etc. In the example of FIG. 6A, the projector 232 is a programmable pattern projector such as a digital light projector (DLP), a MEMS projector, a liquid crystal display (LCD) projector, liquid crystal technology on silicon (LCoS) projector, or the like. In the example of FIG. 6B, a fixed pattern projector 632 (e.g., a laser projector, a chrome on glass LCD projector, a diffractive optical element (DOE) projector, a MEMS projector, etc.) is used instead of a programmable pattern projector.

The images 634, 636 are transmitted as imaged left and right code pattern to an inference framework 620. An example of the inference framework 620 is TenserFlow Lite, which is an open source deep learning framework for on-device (e.g., on scanner) inference. The inference framework 620 uses the machine learning model 228 to generate (or infer) a disparity map 622. The disparity map 622, which is a predicted or estimated disparity map, is then used to generate a point cloud (e.g., a predicted point cloud) using triangulation techniques. For example, a triangulation algorithm (e.g., an algorithm that computes the intersection between two rays, such as a mid-point technique and a direct linear transform technique) is applied to the disparity map 622 to generate a dense point cloud 626 (e.g., the new point cloud 242). The triangulation algorithm can utilize stereo calibration 623 to calibrate the image pair.

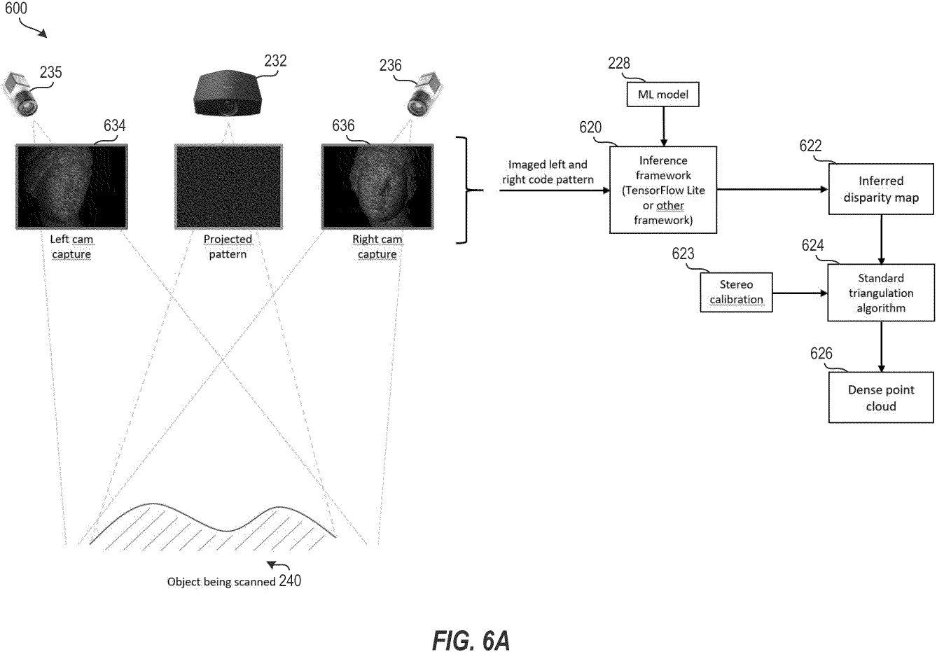

FIG. 7 depicts a flow diagram of a method for denoising data, such as a point cloud, according to one or more embodiments described herein. The method 500 can be performed by any suitable computing device, processing system, processing device, scanner, etc. such as the computing devices, processing systems, processing devices, and scanners described herein. The aspects of the method 500 are now described in more detail with reference to FIG. 2 but are not so limited.

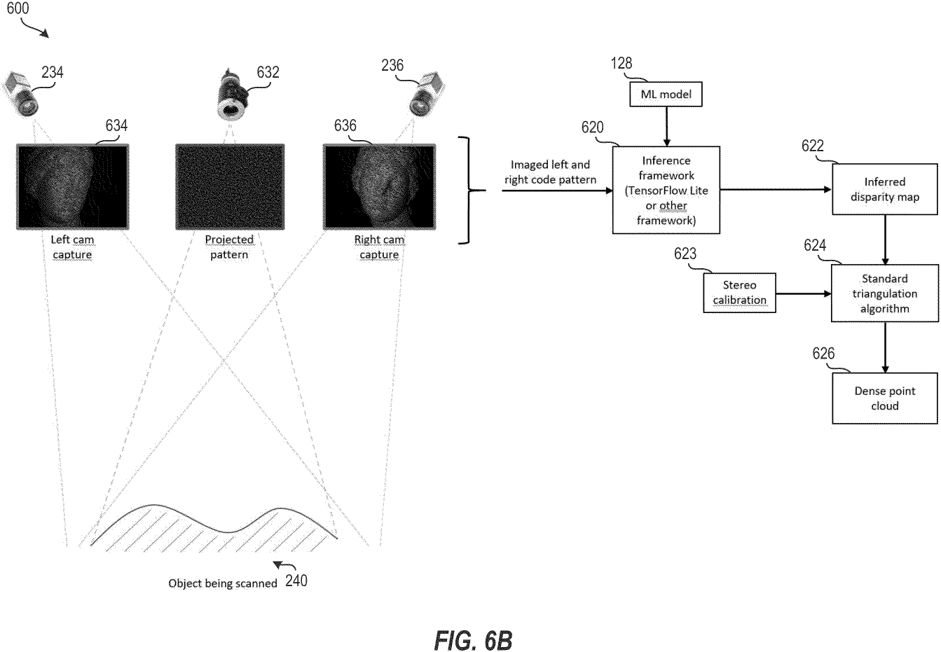

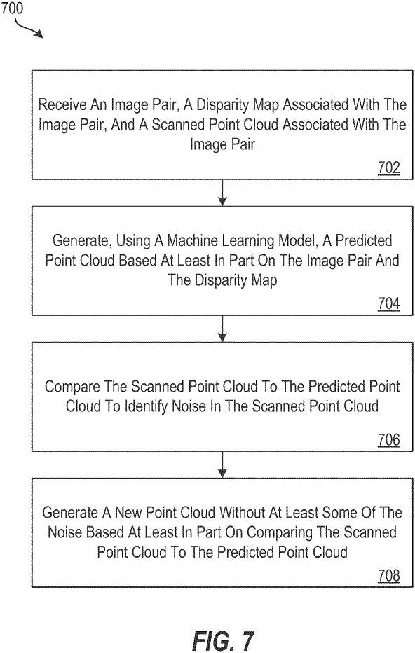

At block 702, a processing device (e.g., the processor 238 of the scanner 230) receives an image pair. For example, scanner 230 captures images (an image pair) using the left and right cameras 234, 236 of the object 240. The scanner 230 uses the image pair to calculate a disparity map associated with the image pair. The image pair and the disparity map are used to generate a scanned point cloud of the object 240. In some examples, the processing device can receive the image pair, the disparity map, and the scanned point cloud without having to process the image pair to calculate the disparity map or to generate the scanned point cloud. FIG. 8A depicts an example of a scanned point cloud 800A according to one or more embodiments described herein.

At block 704, the processing device (e.g., the processor 238 of the scanner 230) uses a machine learning model (e.g., the machine learning model 228) to generate a predicted point cloud based at least in part on the image pair and the disparity map. The machine learning model 228 (e.g., a random forest model) can be trained using left and right images and a corresponding disparity map. In this step, the machine learning model 228 can, for example, create a disparity map, which in a next step can be processed using computer vision techniques that have as an output the predicted point cloud. Because the machine learning model 228 is trained to reduce/remove noise from point clouds, the predicted point cloud should have less noise than the scanned point cloud. FIG. 8B depicts an example of a predicted point cloud 800B according to one or more embodiments described herein.

At block 706, the processing device (e.g., the processor 238 of the scanner 230) compares the scanned point cloud to the predicted point cloud to identify noise in the scanned point cloud. According to one or more embodiments described herein, generating the predicted point cloud is performed by generating, using the machine learning model, a predicted disparity map based at least in part on the image pair. As an example, the predicted point cloud is generated using triangulation. Once the predicted disparity map is generated, the predicted point cloud is then generated using the predicted disparity map. As an example, the comparison can be a union operation, and results of the union operation represent real points to be included in a new point cloud (e.g., the new point cloud 242). For example, the scanned point cloud 800A of FIG. 8A is compared to the predicted point cloud 800B of FIG. B.

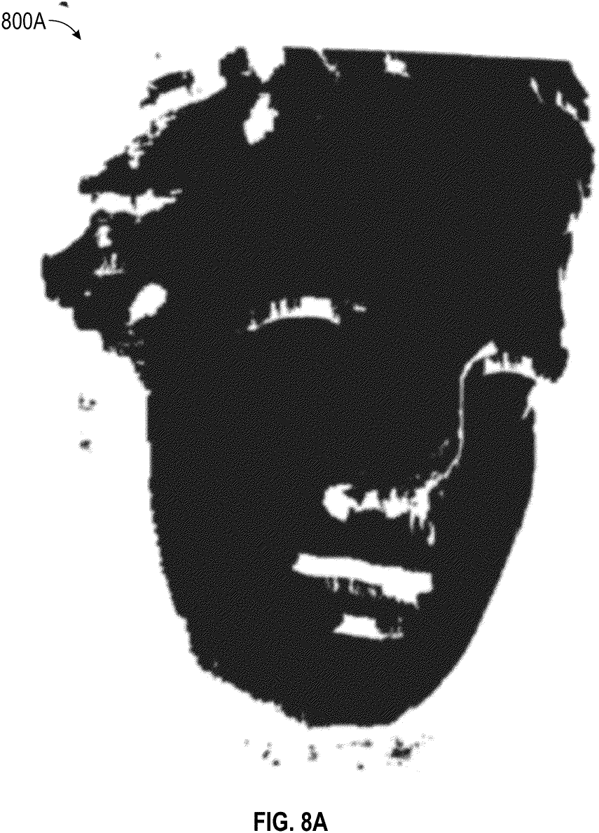

At block 708, the processing device (e.g., the processor 238 of the scanner 230) generates the new point cloud without at least some of the noise based at least in part on comparing the scanned point cloud to the predicted point cloud. The new point cloud can include points from the scanned point cloud and from the predicted point cloud. FIG. 9 depicts an example of a new point cloud 900 as a comparison between the scanned point cloud 800A of FIG. 8A and the predicted point cloud 800B of FIG. 8B according to one or more embodiments described herein.

Additional processes also may be included, and it should be understood that the process depicted in FIG. 7 represents an illustration, and that other processes may be added or existing processes may be removed, modified, or rearranged without departing from the scope of the present disclosure.

FIG. 10A depicts a modular inspection system 1000 according to an embodiment. FIG. 10B depicts an exploded view of the modular inspection system 1000 of FIG. 10A according to an embodiment. The modular inspection system 1000 includes frame segments that mechanically and electrically couple together to form a frame 1002.

The frame segments can include one or more measurement device link segments 1004a, 1004b, 1004c (collectively referred to as “measurement device link segments 904”). The frame segments can also include one or more joint link segments 906a, 906b (collectively referred to as “joint link segments 906”). Various possible configurations of measurement device link segments and joint link segments are depicted and described in U.S. Pat. Publication No. 2021/0048291, which is incorporated by reference herein in its entirety.

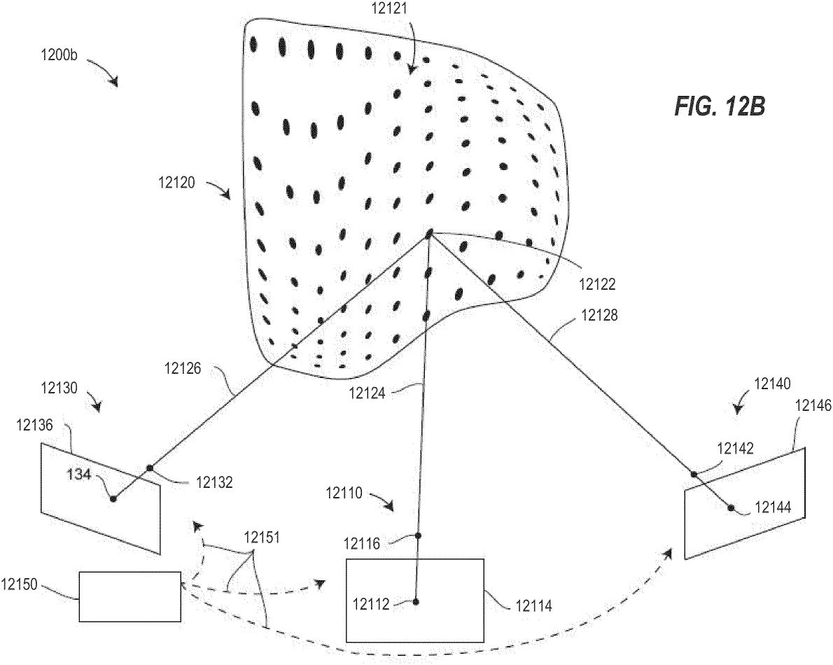

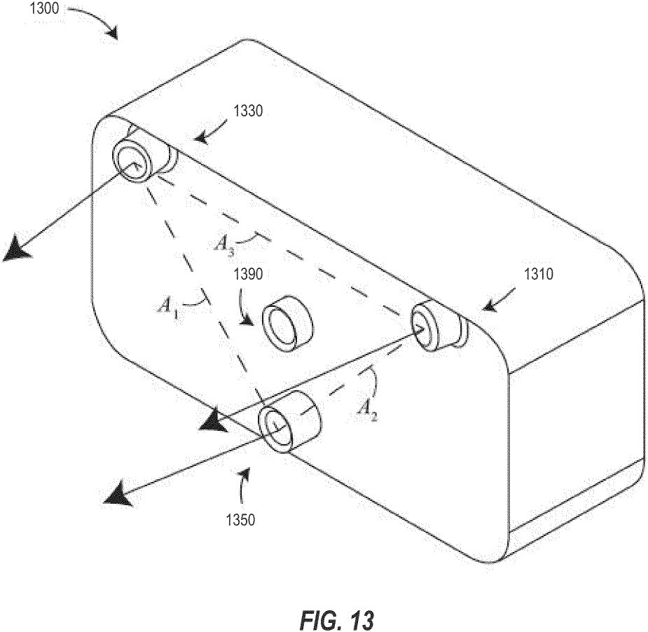

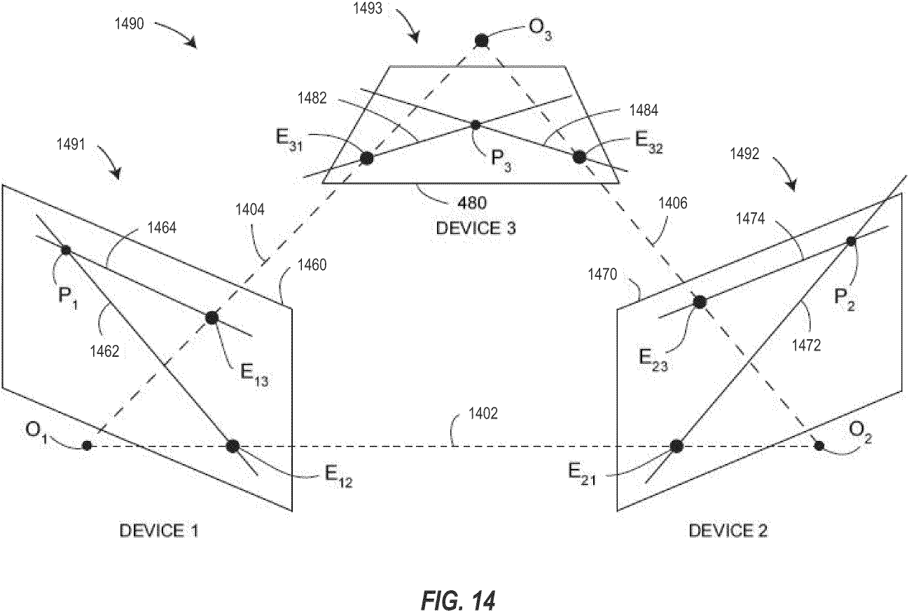

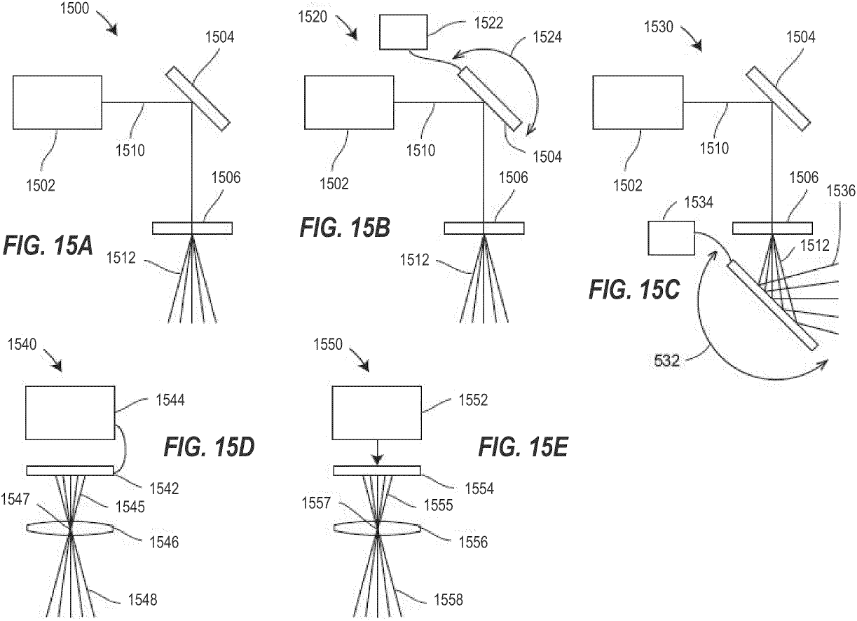

The measurement device link segments 1004 include one or more measurement devices. Examples of measurement devices are described herein and can include: the triangulation scanner 1101 shown in FIGS. 11A, 11B, 11C, 11D, 11E; the triangulation scanner 1200a shown in FIG. 12A; the triangulation scanner 1300 shown in FIG. 13; the triangulation scanner 1600 shown in FIG. 16A; the triangulation scanner 1620 shown in FIG. 16B; the triangulation scanner 1640 shown in FIG. 16C; or the like.

Measurement devices, such as the triangulation scanners described herein, are often used in the inspection of objects to determine in the object is in conformance with specifications. When objects are large, such as with automobiles for example, these inspections may be difficult and time consuming. To assist in these inspections, sometimes non-contact three-dimensional (3D) coordinate measurement devices are used in the inspection process. An example of such a measurement device is a 3D laser scanner time-of-flight (TOF) coordinate measurement device. A 3D laser scanner of this type steers a beam of light to a non-cooperative target such as a diffusely scattering surface of an object (e.g. the surface of the automobile). A distance meter in the device measures a distance to the object, and angular encoders measure the angles of rotation of two axles in the device. The measured distance and two angles enable a computing device 1010 to determine the 3D coordinates of the target.

In the illustrated embodiment of FIG. 10A, the measurement devices of the measurement device link segments 1004 are triangulation or area scanners, such as that described in commonly owned U.S. Pat. Publication 2017/0054965 and/or U.S. Pat. Publication No. 2018/0321383, the contents of both of which are incorporated herein by reference in their entirety. In an embodiment, an area scanner emits a pattern of light from a projector onto a surface of an object and acquires a pair of images of the pattern on the surface. In at least some instances, the 3D coordinates of the elements of the pattern are able to be determined. In other embodiments, the area scanner may include two projectors and one camera or other suitable combinations of projector(s) and camera(s).

The measurement device link segments 1004 also include electrical components to enable data to be transmitted from the measurement devices of the measurement device link segments 1004 to the computing device 1010 or another suitable device. The joint link segments 1006 can also include electrical components to enable the data to be transmitted from measurement devices of the measurement device link segments 1004 to the computing device 1010.

The frame segments, including one or more of the measurement device link segments 1004 and/or one or more of the joint link segments 1006, can be partially or wholly contained in or connected to one or more base stands 1008a, 1008b. The base stands 1008a, 1008b provide support for the frame 1002 and can be of various sizes, shapes, dimensions, orientations, etc., to provide support for the frame 1002. The base stands 1008a, 1008b can include or be connected to one or more leveling feet 1009a, 1009b, which can be adjusted to level the frame 1002 or otherwise change the orientation of the frame 1002 relative to a surface (not shown) upon which the frame 1002 is placed. Although not shown, the base stands 1008a, 1008b can include one or more measurement devices.

Turning now to FIG. 11A, it may be desired to capture three-dimensional (3D) measurements of objects. For example, the point cloud 130 of FIG. 1 may be captured by the scanner 120. One such example of the scanner 120 is now described. Such example scanner is referred to as a DVMS scanner by FARO®.

In an embodiment illustrated in FIGS. 11A-11B, a triangulation scanner 1101 includes a body 1105, a projector 1120, a first camera 1130, and a second camera 1140. In an embodiment, the projector optical axis 1122 of the projector 1120, the first-camera optical axis 1132 of the first camera 1130, and the second-camera optical axis 1142 of the second camera 1140 all lie on a common plane 1150, as shown in FIGS. 11C, 11D. In some embodiments, an optical axis passes through a center of symmetry of an optical system, which might be a projector or a camera, for example. For example, an optical axis may pass through a center of curvature of lens surfaces or mirror surfaces in an optical system. The common plane 1150, also referred to as a first plane 1150, extends perpendicular into and out of the paper in FIG. 11D.

In an embodiment, the body 1105 includes a bottom support structure 1106, a top support structure 1107, spacers 1108, camera mounting plates 1109, bottom mounts 1110, dress cover 1111, windows 1112 for the projector and cameras, Ethernet connectors 1113, and GPIO connector 1114. In addition, the body includes a front side 1115 and a back side 1116. In an embodiment, the bottom support structure 1106 and the top support structure 1107 are flat plates made of carbon-fiber composite material. In an embodiment, the carbon-fiber composite material has a low coefficient of thermal expansion (CTE). In an embodiment, the spacers 1108 are made of aluminum and are sized to provide a common separation between the bottom support structure 1106 and the top support structure 1107.

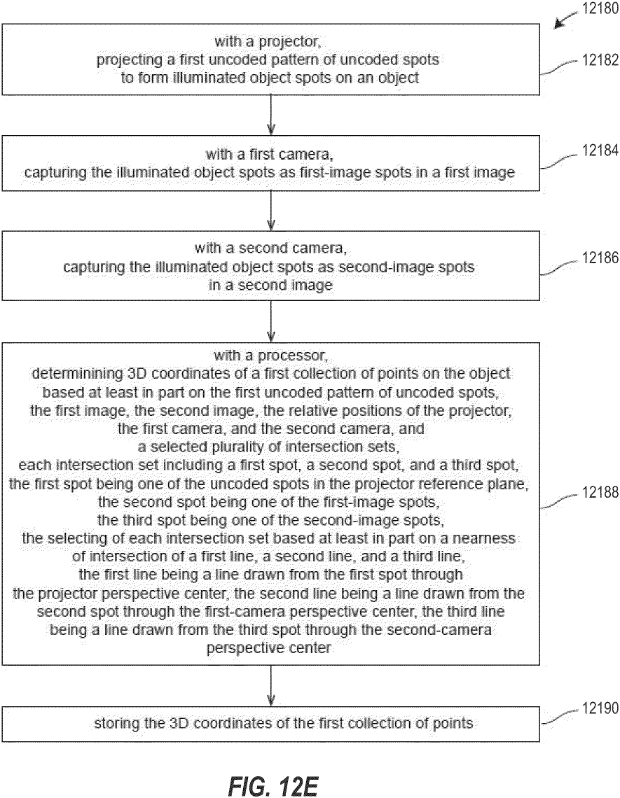

In an embodiment, the projector 1120 includes a projector body 1124 and a projector front surface 1126. In an embodiment, the projector 1120 includes a light source 1125 that attaches to the projector body 1124 that includes a turning mirror and a diffractive optical element (DOE), as explained herein below with respect to FIGS. 15A, 15B, 15C. The light source 1125 may be a laser, a superluminescent diode, or a partially coherent LED, for example. In an embodiment, the DOE produces an array of spots arranged in a regular pattern. In an embodiment, the projector 1120 emits light at a near infrared wavelength.

In an embodiment, the first camera 1130 includes a first-camera body 1134 and a first-camera front surface 36. In an embodiment, the first camera includes a lens, a photosensitive array, and camera electronics. The first camera 1130 forms on the photosensitive array a first image of the uncoded spots projected onto an object by the projector 1120. In an embodiment, the first camera responds to near infrared light.

In an embodiment, the second camera 1140 includes a second-camera body 1144 and a second-camera front surface 1146. In an embodiment, the second camera includes a lens, a photosensitive array, and camera electronics. The second camera 1140 forms a second image of the uncoded spots projected onto an object by the projector 1120. In an embodiment, the second camera responds to light in the near infrared spectrum. In an embodiment, a processor 1102 is used to determine 3D coordinates of points on an object according to methods described herein below. The processor 1102 may be included inside the body 1105 or may be external to the body. In further embodiments, more than one processor is used. In still further embodiments, the processor 1102 may be remotely located from the triangulation scanner.

FIG. 11E is a top view of the triangulation scanner 1101. A projector ray 1128 extends along the projector optical axis from the body of the projector 1124 through the projector front surface 1126. In doing so, the projector ray 1128 passes through the front side 1115. A first-camera ray 1138 extends along the first-camera optical axis 1132 from the body of the first camera 1134 through the first-camera front surface 1136. In doing so, the front-camera ray 1138 passes through the front side 1115. A second-camera ray 1148 extends along the second-camera optical axis 1142 from the body of the second camera 1144 through the second-camera front surface 1146. In doing so, the second-camera ray 1148 passes through the front side 1115.

FIG. 12A shows elements of a triangulation scanner 1200a that might, for example, be the triangulation scanner 1101 shown in FIGS. 11A-11E. In an embodiment, the triangulation scanner 1200a includes a projector 1250, a first camera 1210, and a second camera 1230. In an embodiment, the projector 1250 creates a pattern of light on a pattern generator plane 1252. An exemplary corrected point 1253 on the pattern projects a ray of light 1251 through the perspective center 1258 (point D) of the lens 1254 onto an object surface 1270 at a point 1272 (point F). The point 1272 is imaged by the first camera 1210 by receiving a ray of light from the point 1272 through the perspective center 1218 (point E) of the lens 1214 onto the surface of a photosensitive array 1212 of the camera as a corrected point 1220. The point 1220 is corrected in the read-out data by applying a correction value to remove the effects of lens aberrations. The point 1272 is likewise imaged by the second camera 1230 by receiving a ray of light from the point 1272 through the perspective center 1238 (point C) of the lens 1234 onto the surface of the photosensitive array 1232 of the second camera as a corrected point 1235. It should be understood that as used herein any reference to a lens includes any type of lens system whether a single lens or multiple lens elements, including an aperture within the lens system. It should be understood that any reference to a projector in this document refers not only to a system projecting with a lens or lens system an image plane to an object plane. The projector does not necessarily have a physical pattern-generating plane 1252 but may have any other set of elements that generate a pattern. For example, in a projector having a DOE, the diverging spots of light may be traced backward to obtain a perspective center for the projector and also to obtain a reference projector plane that appears to generate the pattern. In most cases, the projectors described herein propagate uncoded spots of light in an uncoded pattern. However, a projector may further be operable to project coded spots of light, to project in a coded pattern, or to project coded spots of light in a coded pattern. In other words, in some aspects of the disclosed embodiments, the projector is at least operable to project uncoded spots in an uncoded pattern but may in addition project in other coded elements and coded patterns.

In an embodiment where the triangulation scanner 1200a of FIG. 12A is a single-shot scanner that determines 3D coordinates based on a single projection of a projection pattern and a single image captured by each of the two cameras, then a correspondence between the projector point 1253, the image point 1220, and the image point 1235 may be obtained by matching a coded pattern projected by the projector 1250 and received by the two cameras 1210, 1230. Alternatively, the coded pattern may be matched for two of the three elements - for example, the two cameras 1210, 1230 or for the projector 1250 and one of the two cameras 1210 or 1230. This is possible in a single-shot triangulation scanner because of coding in the projected elements or in the projected pattern or both.

After a correspondence is determined among projected and imaged elements, a triangulation calculation is performed to determine 3D coordinates of the projected element on an object. For FIG. 12A, the elements are uncoded spots projected in a uncoded pattern. In an embodiment, a triangulation calculation is performed based on selection of a spot for which correspondence has been obtained on each of two cameras. In this embodiment, the relative position and orientation of the two cameras is used. For example, the baseline distance B3 between the perspective centers 1218 and 1238 is used to perform a triangulation calculation based on the first image of the first camera 1210 and on the second image of the second camera 1230. Likewise, the baseline B1 is used to perform a triangulation calculation based on the projected pattern of the projector 1250 and on the second image of the second camera 1230. Similarly, the baseline B2 is used to perform a triangulation calculation based on the projected pattern of the projector 1250 and on the first image of the first camera 1210. In an embodiment, the correspondence is determined based at least on an uncoded pattern of uncoded elements projected by the projector, a first image of the uncoded pattern captured by the first camera, and a second image of the uncoded pattern captured by the second camera. In an embodiment, the correspondence is further based at least in part on a position of the projector, the first camera, and the second camera. In a further embodiment, the correspondence is further based at least in part on an orientation of the projector, the first camera, and the second camera.

The term “uncoded element” or “uncoded spot” as used herein refers to a projected or imaged element that includes no internal structure that enables it to be distinguished from other uncoded elements that are projected or imaged. The term “uncoded pattern” as used herein refers to a pattern in which information is not encoded in the relative positions of projected or imaged elements. For example, one method for encoding information into a projected pattern is to project a quasi-random pattern of “dots” in which the relative position of the dots is known ahead of time and can be used to determine correspondence of elements in two images or in a projection and an image. Such a quasi-random pattern contains information that may be used to establish correspondence among points and hence is not an example of a uncoded pattern. An example of an uncoded pattern is a rectilinear pattern of projected pattern elements.

In an embodiment, uncoded spots are projected in an uncoded pattern as illustrated in the scanner system 12100 of FIG. 12B. In an embodiment, the scanner system 12100 includes a projector 12110, a first camera 12130, a second camera 12140, and a processor 12150. The projector projects an uncoded pattern of uncoded spots off a projector reference plane 12114. In an embodiment illustrated in FIGS. 12B and 12C, the uncoded pattern of uncoded spots is a rectilinear array 12111 of circular spots that form illuminated object spots 12121 on the object 12120. In an embodiment, the rectilinear array of spots 12111 arriving at the object 12120 is modified or distorted into the pattern of illuminated object spots 12121 according to the characteristics of the object 12120. An exemplary uncoded spot 12112 from within the projected rectilinear array 12111 is projected onto the object 12120 as a spot 12122. The direction from the projector spot 12112 to the illuminated object spot 12122 may be found by drawing a straight line 12124 from the projector spot 12112 on the reference plane 12114 through the projector perspective center 12116. The location of the projector perspective center 12116 is determined by the characteristics of the projector optical system.

In an embodiment, the illuminated object spot 12122 produces a first image spot 12134 on the first image plane 12136 of the first camera 12130. The direction from the first image spot to the illuminated object spot 12122 may be found by drawing a straight line 12126 from the first image spot 12134 through the first camera perspective center 12132. The location of the first camera perspective center 12132 is determined by the characteristics of the first camera optical system.

In an embodiment, the illuminated object spot 12122 produces a second image spot 12144 on the second image plane 12146 of the second camera 12140. The direction from the second image spot 12144 to the illuminated object spot 12122 may be found by drawing a straight line 12126 from the second image spot 12144 through the second camera perspective center 12142. The location of the second camera perspective center 12142 is determined by the characteristics of the second camera optical system.

In an embodiment, a processor 12150 is in communication with the projector 12110, the first camera 12130, and the second camera 12140. Either wired or wireless channels 12151 may be used to establish connection among the processor 12150, the projector 12110, the first camera 12130, and the second camera 12140. The processor may include a single processing unit or multiple processing units and may include components such as microprocessors, field programmable gate arrays (FPGAs), digital signal processors (DSPs), and other electrical components. The processor may be local to a scanner system that includes the projector, first camera, and second camera, or it may be distributed and may include networked processors. The term processor encompasses any type of computational electronics and may include memory storage elements.

FIG. 12E shows elements of a method 12180 for determining 3D coordinates of points on an object. An element 12182 includes projecting, with a projector, a first uncoded pattern of uncoded spots to form illuminated object spots on an object. FIGS. 12B, 12C illustrate this element 12182 using an embodiment 12100 in which a projector 12110 projects a first uncoded pattern of uncoded spots 12111 to form illuminated object spots 12121 on an object 12120.

A method element 12184 includes capturing with a first camera the illuminated object spots as first-image spots in a first image. This element is illustrated in FIG. 12B using an embodiment in which a first camera 12130 captures illuminated object spots 12121, including the first-image spot 12134, which is an image of the illuminated object spot 12122. A method element 12186 includes capturing with a second camera the illuminated object spots as second-image spots in a second image. This element is illustrated in FIG. 12B using an embodiment in which a second camera 140 captures illuminated object spots 12121, including the second-image spot 12144, which is an image of the illuminated object spot 12122.

A first aspect of method element 12188 includes determining with a processor 3D coordinates of a first collection of points on the object based at least in part on the first uncoded pattern of uncoded spots, the first image, the second image, the relative positions of the projector, the first camera, and the second camera, and a selected plurality of intersection sets. This aspect of the element 12188 is illustrated in FIGS. 12B, 12C using an embodiment in which the processor 12150 determines the 3D coordinates of a first collection of points corresponding to object spots 12121 on the object 12120 based at least in the first uncoded pattern of uncoded spots 12111, the first image 12136, the second image 12146, the relative positions of the projector 12110, the first camera 12130, and the second camera 12140, and a selected plurality of intersection sets. An example from FIG. 12B of an intersection set is the set that includes the points 12112, 12134, and 12144. Any two of these three points may be used to perform a triangulation calculation to obtain 3D coordinates of the illuminated object spot 12122 as discussed herein above in reference to FIGS. 12A, 12B.

A second aspect of the method element 12188 includes selecting with the processor a plurality of intersection sets, each intersection set including a first spot, a second spot, and a third spot, the first spot being one of the uncoded spots in the projector reference plane, the second spot being one of the first-image spots, the third spot being one of the second-image spots, the selecting of each intersection set based at least in part on the nearness of intersection of a first line, a second line, and a third line, the first line being a line drawn from the first spot through the projector perspective center, the second line being a line drawn from the second spot through the first-camera perspective center, the third line being a line drawn from the third spot through the second-camera perspective center. This aspect of the element 12188 is illustrated in FIG. 12B using an embodiment in which one intersection set includes the first spot 12112, the second spot 12134, and the third spot 12144. In this embodiment, the first line is the line 12124, the second line is the line 12126, and the third line is the line 12128. The first line 12124 is drawn from the uncoded spot 12112 in the projector reference plane 12114 through the projector perspective center 12116. The second line 12126 is drawn from the first-image spot 12134 through the first-camera perspective center 12132. The third line 12128 is drawn from the second-image spot 12144 through the second-camera perspective center 12142. The processor 12150 selects intersection sets based at least in part on the nearness of intersection of the first line 12124, the second line 12126, and the third line 12128.

The processor 12150 may determine the nearness of intersection of the first line, the second line, and the third line based on any of a variety of criteria. For example, in an embodiment, the criterion for the nearness of intersection is based on a distance between a first 3D point and a second 3D point. In an embodiment, the first 3D point is found by performing a triangulation calculation using the first image point 12134 and the second image point 12144, with the baseline distance used in the triangulation calculation being the distance between the perspective centers 12132 and 12142. In the embodiment, the second 3D point is found by performing a triangulation calculation using the first image point 12134 and the projector point 12112, with the baseline distance used in the triangulation calculation being the distance between the perspective centers 12134 and 12116. If the three lines 12124, 12126, and 12128 nearly intersect at the object point 12122, then the calculation of the distance between the first 3D point and the second 3D point will result in a relatively small distance. On the other hand, a relatively large distance between the first 3D point and the second 3D would indicate that the points 12112, 12134, and 12144 did not all correspond to the object point 12122.

As another example, in an embodiment, the criterion for the nearness of the intersection is based on a maximum of closest-approach distances between each of the three pairs of lines. This situation is illustrated in FIG. 12D. A line of closest approach 12125 is drawn between the lines 12124 and 12126. The line 12125 is perpendicular to each of the lines 12124, 12126 and has a nearness-of-intersection length a. A line of closest approach 12127 is drawn between the lines 12126 and 12128. The line 12127 is perpendicular to each of the lines 12126, 12128 and has length b. A line of closest approach 12129 is drawn between the lines 12124 and 12128. The line 12129 is perpendicular to each of the lines 12124, 12128 and has length c. According to the criterion described in the embodiment above, the value to be considered is the maximum of a, b, and c. A relatively small maximum value would indicate that points 12112, 12134, and 12144 have been correctly selected as corresponding to the illuminated object point 12122. A relatively large maximum value would indicate that points 12112, 12134, and 12144 were incorrectly selected as corresponding to the illuminated object point 12122.

The processor 12150 may use many other criteria to establish the nearness of intersection. For example, for the case in which the three lines were coplanar, a circle inscribed in a triangle formed from the intersecting lines would be expected to have a relatively small radius if the three points 12112, 12134, 12144 corresponded to the object point 12122. For the case in which the three lines were not coplanar, a sphere having tangent points contacting the three lines would be expected to have a relatively small radius.

It should be noted that the selecting of intersection sets based at least in part on a nearness of intersection of the first line, the second line, and the third line is not used in most other projector-camera methods based on triangulation. For example, for the case in which the projected points are coded points, which is to say, recognizable as corresponding when compared on projection and image planes, there is no need to determine a nearness of intersection of the projected and imaged elements. Likewise, when a sequential method is used, such as the sequential projection of phase-shifted sinusoidal patterns, there is no need to determine the nearness of intersection as the correspondence among projected and imaged points is determined based on a pixel-by-pixel comparison of phase determined based on sequential readings of optical power projected by the projector and received by the camera(s). The method element 12190 includes storing 3D coordinates of the first collection of points.

An alternative method that uses the intersection of epipolar lines on epipolar planes to establish correspondence among uncoded points projected in an uncoded pattern is described in U.S. Pat. No. 9,599,455 (‘455) to Heidemann, et al., the contents of which are incorporated by reference herein. In an embodiment of the method described in Patent ‘455, a triangulation scanner places a projector and two cameras in a triangular pattern. An example of a triangulation scanner 1300 having such a triangular pattern is shown in FIG. 13. The triangulation scanner 1300 includes a projector 1350, a first camera 1310, and a second camera 1330 arranged in a triangle having sides A1-A2-A3. In an embodiment, the triangulation scanner 1300 may further include an additional camera 1390 not used for triangulation but to assist in registration and colorization.

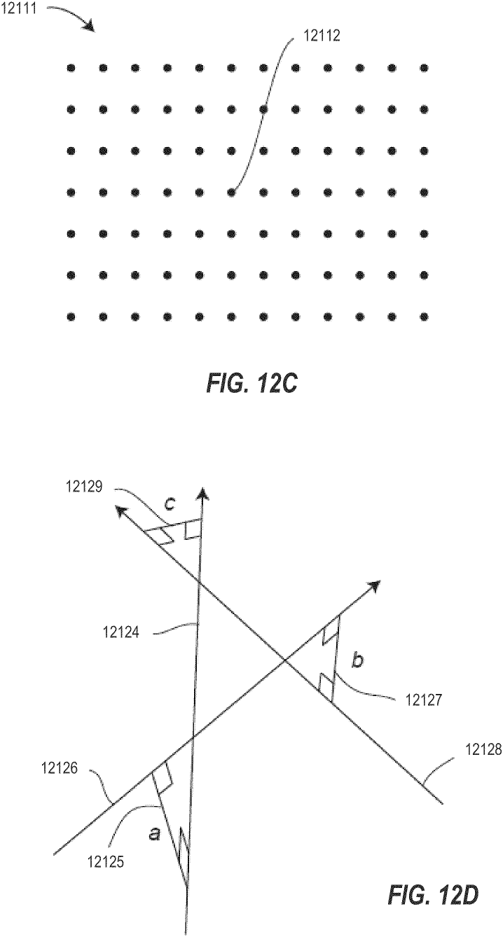

Referring now to FIG. 14 the epipolar relationships for a 3D imager (triangulation scanner) 1490 correspond with 3D imager 1300 of FIG. 13 in which two cameras and one projector are arranged in the shape of a triangle having sides 1402, 1404, 1406. In general, the device 1, device 2, and device 3 may be any combination of cameras and projectors as long as at least one of the devices is a camera. Each of the three devices 1491, 1492, 1493 has a perspective center O1, O2, O3, respectively, and a reference plane 1460, 1470, and 1480, respectively. In FIG. 14, the reference planes 1460, 1470, 1480 are epipolar planes corresponding to physical planes such as an image plane of a photosensitive array or a projector plane of a projector pattern generator surface but with the planes projected to mathematically equivalent positions opposite the perspective centers O1, O2, O3. Each pair of devices has a pair of epipoles, which are points at which lines drawn between perspective centers intersect the epipolar planes. Device 1 and device 2 have epipoles E12, E21 on the planes 1460, 1470, respectively. Device 1 and device 3 have epipoles E13, E31, respectively on the planes 1460, 1480, respectively. Device 2 and device 3 have epipoles E23, E32 on the planes 1470, 1480, respectively. In other words, each reference plane includes two epipoles. The reference plane for device 1 includes epipoles E12 and E13. The reference plane for device 2 includes epipoles E21 and E23. The reference plane for device 3 includes epipoles E31 and E32.

In an embodiment, the device 3 is a projector 1493, the device 1 is a first camera 1491, and the device 2 is a second camera 1492. Suppose that a projection point P3, a first image point P1, and a second image point P2 are obtained in a measurement. These results can be checked for consistency in the following way.

To check the consistency of the image point P1, intersect the plane P3-E31-E13 with the reference plane 1460 to obtain the epipolar line 1464. Intersect the plane P2-E21-E12 to obtain the epipolar line 1462. If the image point P1 has been determined consistently, the observed image point P1 will lie on the intersection of the determined epipolar lines 1462 and 1464.

To check the consistency of the image point P2, intersect the plane P3-E32-E23 with the reference plane 1470 to obtain the epipolar line 1474. Intersect the plane P1-E12-E21 to obtain the epipolar line 1472. If the image point P2 has been determined consistently, the observed image point P2 will lie on the intersection of the determined epipolar lines 1472 and 1474.

To check the consistency of the projection point P3, intersect the plane P2-E23-E32 with the reference plane 1480 to obtain the epipolar line 1484. Intersect the plane P1-E13-E31 to obtain the epipolar line 1482. If the projection point P3 has been determined consistently, the projection point P3 will lie on the intersection of the determined epipolar lines 1482 and 1484.

It should be appreciated that since the geometric configuration of device 1, device 2 and device 3 are known, when the projector 1493 emits a point of light onto a point on an object that is imaged by cameras 1491, 1492, the 3D coordinates of the point in the frame of reference of the 3D imager 1490 may be determined using triangulation methods.

Note that the approach described herein above with respect to FIG. 14 may not be used to determine 3D coordinates of a point lying on a plane that includes the optical axes of device 1, device 2, and device 3 since the epipolar lines are degenerate (fall on top of one another) in this case. In other words, in this case, intersection of epipolar lines is no longer obtained. Instead, in an embodiment, determining self-consistency of the positions of an uncoded spot on the projection plane of the projector and the image planes of the first and second cameras is used to determine correspondence among uncoded spots, as described herein above in reference to FIGS. 12B, 12C, 12D, 12E.

FIGS. 15A, 15B, 15C, 15D, 15E are schematic illustrations of alternative embodiments of the projector 1120. In FIG. 15A, a projector 1500 includes a light source, mirror 1504, and diffractive optical element (DOE) 1506. The light source 1502 may be a laser, a superluminescent diode, or a partially coherent LED, for example. The light source 1502 emits a beam of light 1510 that reflects off mirror 1504 and passes through the DOE. In an embodiment, the DOE 11506 produces an array of diverging and uniformly distributed light spots 512. In FIG. 15B, a projector 1520 includes the light source 1502, mirror 1504, and DOE 1506 as in FIG. 15A. However, in the projector 1520 of FIG. 15B, the mirror 1504 is attached to an actuator 1522 that causes rotation 1524 or some other motion (such as translation) in the mirror. In response to the rotation 1524, the reflected beam off the mirror 1504 is redirected or steered to a new position before reaching the DOE 1506 and producing the collection of light spots 1512. In system 1530 of FIG. 15C, the actuator is applied to a mirror 1532 that redirects the beam 1512 into a beam 1536. Other types of steering mechanisms such as those that employ mechanical, optical, or electro-optical mechanisms may alternatively be employed in the systems of FIGS. 15A, 15B, 15C. In other embodiments, the light passes first through the pattern generating element 1506 and then through the mirror 1504 or is directed towards the object space without a mirror 1504.

In the system 1540 of FIG. 5D, an electrical signal is provided by the electronics 1544 to drive a projector pattern generator 1542, which may be a pixel display such as a Liquid Crystal on Silicon (LCoS) display to serve as a pattern generator unit, for example. The light 1545 from the LCoS display 1542 is directed through the perspective center 1547 from which it emerges as a diverging collection of uncoded spots 1548. In system 1550 of FIG. 15E, a source is light 1552 may emit light that may be sent through or reflected off of a pattern generating unit 1554. In an embodiment, the source of light 1552 sends light to a digital micromirror device (DMD), which reflects the light 1555 through a lens 1556. In an embodiment, the light is directed through a perspective center 1557 from which it emerges as a diverging collection of uncoded spots 1558 in an uncoded pattern. In another embodiment, the source of light 1562 passes through a slide 1554 having an uncoded pattern of dots before passing through a lens 1556 and proceeding as an uncoded pattern of light 1558. In another embodiment, the light from the light source 1552 passes through a lenslet array 1554 before being redirected into the pattern 1558. In this case, inclusion of the lens 1556 is optional.

The actuators 1522, 1534, also referred to as beam steering mechanisms, may be any of several types such as a piezo actuator, a microelectromechanical system (MEMS) device, a magnetic coil, or a solid-state deflector.

FIG. 16A is an isometric view of a triangulation scanner 1600 that includes a single camera 1602 and two projectors 1604, 1606, these having windows 1603, 1605, 1607, respectively. In the triangulation scanner 1600, the projected uncoded spots by the projectors 1604, 1606 are distinguished by the camera 1602. This may be the result of a difference in a characteristic in the uncoded projected spots. For example, the spots projected by the projector 1604 may be a different color than the spots projected by the projector 1606 if the camera 1602 is a color camera. In another embodiment, the triangulation scanner 1600 and the object under test are stationary during a measurement, which enables images projected by the projectors 1604, 1606 to be collected sequentially by the camera 1602. The methods of determining correspondence among uncoded spots and afterwards in determining 3D coordinates are the same as those described earlier in FIG. 12 for the case of two cameras and one projector. In an embodiment, the triangulation scanner 1600 includes a processor 1102 that carries out computational tasks such as determining correspondence among uncoded spots in projected and image planes and in determining 3D coordinates of the projected spots.

FIG. 16B is an isometric view of a triangulation scanner 1620 that includes a projector 1622 and in addition includes three cameras: a first camera 1624, a second camera 1626, and a third camera 1628. These aforementioned projector and cameras are covered by windows 1623, 1625, 1627, 1629, respectively. In the case of a triangulation scanner having three cameras and one projector, it is possible to determine the 3D coordinates of projected spots of uncoded light without knowing in advance the pattern of dots emitted from the projector. In this case, lines can be drawn from an uncoded spot on an object through the perspective center of each of the three cameras. The drawn lines may each intersect with an uncoded spot on each of the three cameras. Triangulation calculations can then be performed to determine the 3D coordinates of points on the object surface. In an embodiment, the triangulation scanner 1620 includes the processor 1102 that carries out operational methods such as verifying correspondence among uncoded spots in three image planes and in determining 3D coordinates of projected spots on the object.

FIG. 16C is an isometric view of a triangulation scanner 1640 like that of FIG. 1A except that it further includes a camera 1642, which is coupled to the triangulation scanner 1640. In an embodiment the camera 1642 is a color camera that provides colorization to the captured 3D image. In a further embodiment, the camera 1642 assists in registration when the camera 1642 is moved - for example, when moved by an operator or by a robot.

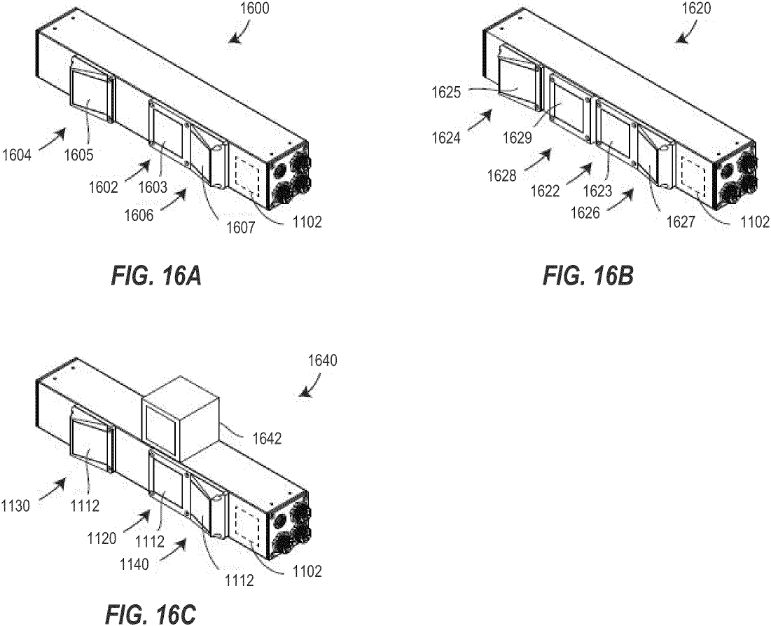

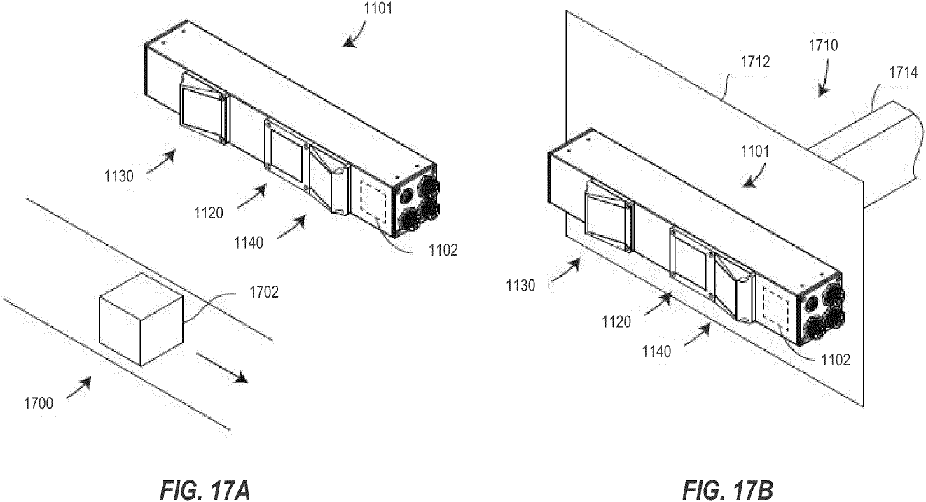

FIGS. 17A, 17B illustrate two different embodiments for using the triangulation scanner 1 in an automated environment. FIG. 17A illustrates an embodiment in which a scanner 1101 is fixed in position and an object under test 1702 is moved, such as on a conveyor belt 1700 or other transport device. The scanner 1101 obtains 3D coordinates for the object 1702. In an embodiment, a processor, either internal or external to the scanner 1101, further determines whether the object 1702 meets its dimensional specifications. In some embodiments, the scanner 1101 is fixed in place, such as in a factory or factory cell for example, and used to monitor activities. In one embodiment, the processor 1102 monitors whether there is risk of contact with humans from moving equipment in a factory environment and, in response, issue warnings, alarms, or cause equipment to stop moving.

FIG. 17B illustrates an embodiment in which a triangulation scanner 1101 is attached to a robot end effector 1710, which may include a mounting plate 1712 and robot arm 1714. The robot may be moved to measure dimensional characteristics of one or more objects under test. In further embodiments, the robot end effector is replaced by another type of moving structure. For example, the triangulation scanner 1101 may be mounted on a moving portion of a machine tool.

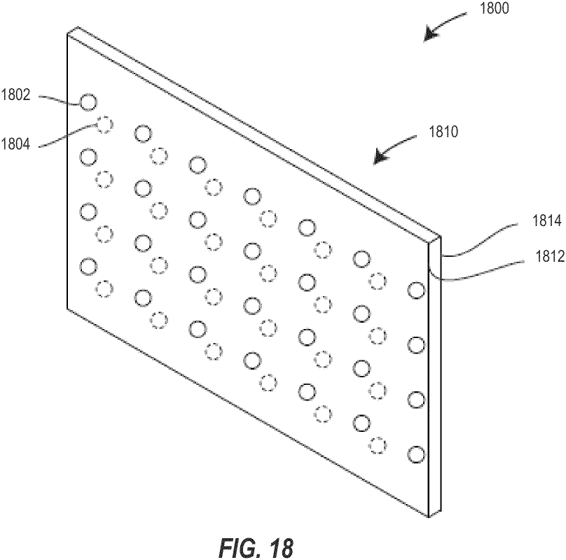

FIG. 18 is a schematic isometric drawing of a measurement application 1800 that may be suited to the triangulation scanners described herein above. In an embodiment, a triangulation scanner 1101 sends uncoded spots of light onto a sheet of translucent or nearly transparent material 1810 such as glass. The uncoded spots of light 1802 on the glass front surface 1812 arrive at an angle to a normal vector of the glass front surface 1812. Part of the optical power in the uncoded spots of light 1802 pass through the front surface 1812, are reflected off the back surface 1814 of the glass, and arrive a second time at the front surface 1812 to produce reflected spots of light 1804, represented in FIG. 18 as dashed circles. Because the uncoded spots of light 1802 arrive at an angle with respect to a normal of the front surface 1812, the spots of light 1804 are shifted laterally with respect to the spots of light 1802. If the reflectance of the glass surfaces is relatively high, multiple reflections between the front and back glass surfaces may be picked up by the triangulation scanner 1800.

The uncoded spots of lights 1802 at the front surface 1812 satisfy the criterion described with respect to FIG. 12 in being intersected by lines drawn through perspective centers of the projector and two cameras of the scanner. For example, consider the case in which in FIG. 12A the element 1250 is a projector, the elements 1210, 1230 are cameras, and the object surface 1270 represents the glass front surface 1270. In FIG. 12, the projector 1250 sends light from a point 1253 through the perspective center 1258 onto the object 1270 at the position 1272. Let the point 1253 represent the center of a spot of light 1802 in FIG. 18. The object point 1272 passes through the perspective center 1218 of the first camera onto the first image point 1220. It also passes through the perspective center 1238 of the second camera 1230 onto the second image point 1235. The image points 1200, 1235 represent points at the center of the uncoded spots 1802. By this method, the correspondence in the projector and two cameras is confirmed for an uncoded spot 1802 on the glass front surface 1812. However, for the spots of light 1804 on the front surface that first reflect off the back surface, there is no projector spot that corresponds to the imaged spots. In other words, in the representation of FIG. 12, there is no condition in which the lines 1211, 1231, 1251 intersect in a single point 1272 for the reflected spot 1204. Hence, using this method, the spots at the front surface may be distinguished from the spots at the back surface, which is to say that the 3D coordinates of the front surface are determined without contamination by reflections from the back surface. This is possible as long as the thickness of the glass is large enough and the glass is tilted enough relative to normal incidence. Separation of points reflected off front and back glass surfaces is further enhanced by a relatively wide spacing of uncoded spots in the projected uncoded pattern as illustrated in FIG. 18. Although the method of FIG. 18 was described with respect to the scanner 1, the method would work equally well for other scanner embodiments such as the scanners 1600, 1620, 1640 of FIGS. 16A, 16B, 16C, respectively.

Terms such as processor, controller, computer, DSP, FPGA are understood in this document to mean a computing device that may be located within an instrument, distributed in multiple elements throughout an instrument, or placed external to an instrument.

While embodiments of the invention have been described in detail in connection with only a limited number of embodiments, it should be readily understood that the invention is not limited to such disclosed embodiments. Rather, the embodiments of the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the embodiments of the invention are not to be seen as limited by the foregoing description but is only limited by the scope of the appended claims.

What is claimed is:

1. A method for denoising data, the method comprising:
receiving an image pair, a disparity map associated with the image pair, and a scanned point cloud associated with the image pair;
generating, using a machine learning model, a predicted point cloud based at least in part on the image pair and the disparity map;
comparing the scanned point cloud to the predicted point cloud to identify noise in the scanned point cloud; and
generating a new point cloud without at least some of the noise based at least in part on comparing the scanned point cloud to the predicted point cloud.

2. The method of claim 1, wherein generating the predicted point cloud comprises:
generating, using the machine learning model, a predicted disparity map based at least in part on the image pair; and
generating the predicted point cloud using the predicted disparity map.

3. The method of claim 2, wherein generating the predicted point cloud using the predicted disparity map comprises performing triangulation to generate the predicted point cloud.

4. The method of claim 1, wherein the noise is identified by performing a union operation to identify points in the scanned point cloud and to identify points in the predicted point cloud.

5. The method of claim 4, wherein the new point cloud comprises at least one of the points in the scanned point cloud and at least one of the points in the predicted point cloud.

6. The method of claim 5, wherein the machine learning model is trained using a random forest algorithm.

7. The method of claim 6, wherein the random forest algorithm is a HyperDepth random forest algorithm.

8. The method of claim 6, wherein the random forest algorithm comprises a classification portion that runs a random forest function to predict, for each pixel of the image pair, a class by sparsely sampling a two-dimensional neighborhood.

9. The method of claim 7, wherein the random forest algorithm comprises a regression that predicts continuous class labels that maintain subpixel accuracy.

10. A method comprising:
receiving training data, the training data comprising training pairs of stereo images and a training disparity map associated with each training pair of the pairs of stereo images; and
training, using a random forest approach, a machine learning model based at least in part on the training data, the machine learning model being trained to denoise a point cloud.

11. The method of claim 10, wherein the training data are captured by a scanner.

12. The method of claim 10, further comprising:
receiving an image pair, a disparity map associated with the image pair, and the point cloud;
generating, using the machine learning model, a predicted point cloud based at least in part on the image pair and the disparity map;
comparing the point cloud to the predicted point cloud to identify noise in the point cloud; and
generating a new point cloud without the noise based at least in part on comparing the point cloud to the predicted point cloud.

13. A scanner comprising:
a projector;
a camera;
a memory comprising computer readable instructions and a machine learning model trained to denoise point clouds; and
a processing device for executing the computer readable instructions, the computer readable instructions controlling the processing device to perform operations to:
generate a point cloud of an object of interest; and
generate a new point cloud by denoising the point cloud of the object of interest using the machine learning model.

14. The scanner of claim 13, wherein the machine learning model is trained using a random forest algorithm.

15. The scanner of claim 13, wherein the camera is a first camera, the scanner further comprising a second camera.

16. The scanner of claim 15, wherein capturing the point cloud of the object of interest comprises:
acquiring a pair of images of the object of interest using the first camera and the second camera.

17. The scanner of claim 16, wherein capturing the point cloud of the object of interest further comprises:
calculating a disparity map for the pair of images.

18. The scanner of claim 17, wherein capturing the point cloud of the object of interest further comprises:
generating the point cloud of the object of interest based at least in part on the disparity map.

19. The scanner of claim 13, wherein denoising the point cloud of the object of interest using the machine learning model comprises:
generating, using the machine learning model, a predicted point cloud based at least in part on an image pair and a disparity map associated with the object of interest.

20. The scanner of claim 19, wherein denoising the point cloud of the object of interest using the machine learning model further comprises:
comparing the point cloud of the object of interest to the predicted point cloud to identify noise in the point cloud of the object of interest.

21. The scanner of claim 20, wherein denoising the point cloud of the object of interest using the machine learning model further comprises:
generating the new point cloud without the noise based at least in part on comparing the point cloud of the object of interest to the predicted point cloud.
